(19) United States
(12) Patent Application Publication
(10) Pub. No.: US 2009/0012905 A1
(43) Pub. Date: Jan. 8, 2009

(54) Electronic Advertising System

(76) Inventors: Aleem R. Mawani, Markham (CA); Adam L. Leader, Scarsdale, NY (US); Smita Hashim, Saratoga, CA (US); Thomas L. Phillips, JR., Bronxville, NY (US); Neha Singh, New York, NY (US)

Correspondence Address: FISH & RICHARDSON P.C., PO BOX 1022, MINNEAPOLIS, MN, 55440-1022, US

(21) Appl. No.: 12/167,120

(22) Filed: Jul. 2, 2008

Related U.S. Application Data
(60) Provisional application No. 60/947,908, filed on Jul. 3, 2007.

(51) Int. Cl. G06Q 10/00

(52) U.S. Cl. 705/80; 705/1

(57) ABSTRACT

Publisher information, such as information about available advertising space, may be received from publishers. Advertisers may provide requests associated with a print ad and receive a list of publishers with available print ad space. The list of publishers may include at least one publisher having a specified relationship with the advertiser. The advertiser may provide an offer for placing the print ad in a publication of one or more publishers on the list and may be inhibited from placing an offer for the print ad with publishers having a specified relationship with the advertiser.

### CROSS-REFERENCE TO RELATED APPLICATION

This application claims priority to pending U.S. Provisional Application Ser. No. 60/947,908, entitled “Electronic Advertising System,” filed on Jul. 3, 2007, the entire contents of which are incorporated herein by reference.

### TECHNICAL FIELD

This invention relates to advertising.

### BACKGROUND

An advertiser desiring to place an advertisement in a printed publication (a “print ad”) can enter into an agreement with a publisher of the publication. The agreement generally includes the terms associated with the placement of the print ad. For example, if a print ad is to be placed in a newspaper, the agreement can specify the dates the print ad is to run, the section in the newspaper to place the print ad, the print ad size, and possibly other parameters. Because printed publications include manual processes, human error can lead to a print ad not running according to the terms agreed to between the advertiser and the publisher. For example, the print ad simply may not run at all, the wrong print ad content may be published, the print ad may be inserted into the wrong section of the newspaper and/or may be sized incorrectly. Conventionally, a publisher provides a tearsheet (i.e., a page on which the print ad was placed in the publication) to the advertiser as proof the print ad ran in the publication. Publishers typically have various existing relationships with certain advertisers. A single publisher of multiple publications may transact with advertisers separately for each publication, or may have a single account with an advertiser that relates to numerous publications.

### SUMMARY

In general, in one aspect, the invention features techniques and apparatus whereby publisher information is received from publishers, where the publisher information includes information about available print ad space. A request associated with a print ad is received from an advertiser, and publishers with available print ad space are identified to the advertiser. The identified publishers include one or more of the publishers and at least one publisher having a specified relationship with the advertiser. Placement of the print ad of the advertiser with at least one publisher having the specified relationship with the advertiser is inhibited.

Various implementations can include one or more of the following features. A determination can be made whether the advertiser has a specified relationship with one or more of the identified publishers. An offer can be received from the advertiser defining terms for placing the print ad in a publication of one or more of the identified publishers, including a publication of at least one publisher having the specified relationship with the advertiser. Determining whether the advertiser has the specified relationship with one or more of the identified publishers can include receiving an indication of the specified relationship from the publisher having the specified relationship with the advertiser after the publisher receives the offer from the advertiser.

Inhibiting the advertiser from placing the print ad with a publisher having the specified relationship can include preventing the advertiser from submitting an offer for placing the print ad in a publication of the publisher with whom the advertiser has the specified relationship. In another example, inhibiting the advertiser can include preventing the advertiser from selecting the publisher from a list of the identified publishers presented to the advertiser when the advertiser is generating the offer. An interface can be provided to the advertiser that includes a list of the identified publishers including at least a portion of the publisher information for each publisher and a link for each identified publisher on the list that does not have the specified relationship with the advertiser. The advertiser can select a link to submit an offer for placing the print ad in a publication of the corresponding publisher. An identification of one or more advertisers having the specified relationship to the publisher can be received from at least some of the publishers. In this example, determining whether the advertiser has the specified relationship with one of the identified publishers can include comparing the advertiser to one or more advertisers identified by the publishers.

The request from the advertiser can include search criteria related to publisher attributes and publishers can be identified at least partially based on the received search criteria. The specified relationship can include a previous advertising relationship with a publisher. One or more indicia can be presented to indicate which of the identified publishers has the specified relationship with the advertiser.

A request can be received from the advertiser to submit an offer to the at least one publisher having the specified relationship with the advertiser, and, in response to the request, contact information for the at least one publisher can be presented to the advertiser such that the advertiser can contact the at least one publisher directly. An offer may be received from the advertiser defining terms for placing the print ad in a publication of one or more of the identified publishers, and a rejection of the offer and an identification that the advertiser has the specified relationship with the publisher can be received from at least one of the identified publishers to whom the offer is submitted. Inhibiting placement of the print ad of the advertiser with at least one publisher having the specified relationship can include selectively inhibiting placement based on offer criteria defined by the publisher with the specified relationship with the advertiser. An offer can be received from the advertiser that defines terms for placing the print ad in a publication of one or more of the identified publishers including a publication of at least one publisher having the specified relationship with the advertiser. Selectively inhibiting placement based on the offer criteria can include comparing the offer received from the advertiser having the specified relationship with the publisher to the offer criteria, and accepting the offer for placement if the offer criteria is satisfied and/or accepting the offer for placement if the offer criteria is not satisfied by the one or more other offers.

In general, in another aspect, the invention features a system. The system includes a memory and an analysis module. The memory stores publisher information. The analysis module is adapted to receive publisher information from publishers and receive from an advertiser a request associated with a print ad. The publisher information includes information about available print ad space. The analysis module also is adapted to identify publishers with available print ad space, where the identified publishers includes one or more of the publishers from the plurality of publishers and at least one publisher having a specified relationship with the advertiser, and inhibit placement of the print ad of the advertiser with at least one publisher having the specified relationship with the advertiser.

Various implementations can include one or more of the following features. The system can further include a presentation module adapted to present to the advertiser a list of the identified publishers. The analysis module can be further adapted to inhibit selection of at least one publisher on the list with the specified relationship with the advertiser.

In general, in another aspect, the invention features a system including a means for receiving publisher information from publishers; means for receiving from an advertiser a request associated with a print ad; and means for identifying to the advertiser publishers with available print ad space, where publishers include one or more of the publishers and at least one publisher having a specified relationship with the advertiser. The publisher information includes information about available print ad space. Placement of the print ad of the advertiser with the at least one publisher having the specified relationship with the advertiser is inhibited.

In general, in another aspect, the invention features techniques and apparatus whereby publisher information is received from publishers, the publisher information including information about available print ad space and an identification of advertisers from whom the publisher will entertain offers for ad placement. A request associated with a print ad is received from an advertiser, and publishers with available print ad space are identified to the advertiser. Placement of the print ad of the advertiser with any publisher that has not identified the advertiser as an advertiser from whom the publisher will entertain offers for ad placement is inhibited. Identifying to the advertiser publishers with available print ad space can include determining if the advertiser is an advertiser with whom publishers having available print ad space will entertain offers from, and excluding publishers from the identified publishers those publishers that will not entertain offers from the advertiser.

Implementations of the invention can include none or some of the following advantages. An online marketplace is provided, for example, by way of a web site accessible over the Internet, that brings together multiple publishers and multiple advertisers. The online marketplace is provided by an advertising system manager, who can be compensated for placing prints ads with publishers from advertisers by way of the online marketplace. A publisher with an existing set of advertiser clientele can choose to use the online marketplace for advertisers other than some or all of those included in set. The publisher can thereby choose to carry on an existing relationship with an advertiser outside of the online marketplace, while still participating in the online marketplace in terms of forming new advertiser relationships.

The details of one or more implementations are set forth in the accompanying drawings and the description below. Other features will be apparent from the description and drawings, and from the claims.

### DESCRIPTION OF DRAWINGS

FIG. 1 is a block diagram of an example electronic print ad management system.

FIG. 2 is a flowchart showing an example process for providing an electronic advertising system.

FIGS. 3A-D are example graphical user interfaces associated with one implementation of an electronic advertising system.

FIGS. 4A-B are example graphical user interfaces associated with one implementation of an electronic advertising system.

FIGS. 5A-B illustrate an example process for managing advertisements.

FIGS. 6A-F illustrate example interfaces associated with one implementation of an electronic advertising system.

FIG. 7 is a schematic diagram of an example computer system.

Like reference symbols in the various drawings indicate like elements.

### DETAILED DESCRIPTION

Techniques, methods, apparatus and a system for advertising are described that can be used to facilitate print advertising, being advertising occurring in print for example, in newspapers, magazines, journals, periodicals, flyers, brochures, and other printed publications. An advertisement placed in a printed publication shall be referred to herein as a “print ad”. While reference is made to print ads, the systems and methods disclosed herein can be applied to other forms of sponsored content.

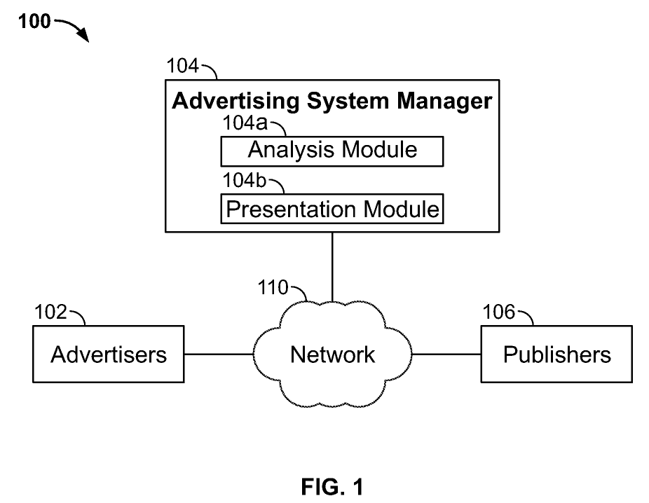

FIG. 1 is a block diagram of an example electronic print ad management system 100. The system 100 includes advertisers 102 and publishers 106. A publisher 106 is an entity that publishes content (e.g., print ads) or places content (e.g., print ads) for publication with another entity. By way of example, reference is made to placing print ads in a publication. Other forms of content can be delivered and published in other forms of media in accordance with the methods, apparatus and systems disclosed herein. An advertiser 104 is an entity that desires to place a print ad in a printed publication. The advertiser 104 can be a direct (e.g., an advertising entity) or indirect supplier (e.g., a middle man) of the print ad.

In some implementations, the advertiser 102 and one or more of the publishers 106 may have a specified relationship, e.g., a previous advertising relationship. In one implementation, certain advertisers may be deemed to have a specified relationship with one or more of the publishers if the advertiser meets certain criteria, e.g., in terms of volumes of ads placed. That is, in one example, the top 300 advertisers in a region or nationally may be deemed to have a previous advertising relationship with certain publishers, whether or not that is actually the case. The significance of having a specified relationship with a publisher, or being deemed to have one, is discussed further below.

The system further includes an advertising system manager 104. The advertising system manager 104 operates to bring the advertisers 102 and publishers 106 together by way, for example, of an online print ad marketplace, as is described further below. A computer network 110, such as a local area network (LAN), wide area network (WAN), the Internet, or a combination thereof, connects the advertisers 102, the advertising system manager 104 and the publishers 106.

In one implementation, the advertising system manager 104 includes an analysis module 104a and a presentation module 104b, both of which can be of the form of executable instructions which are stored on a memory of the advertising system manager and executable by a processor of the advertising system manager. The analysis module 104a can receive publisher information from a plurality of publishers; receive from an advertiser a request associated with a print ad; generate a list of publishers with available print ad space, where the list of publishers includes one or more of the publishers from the plurality of publishers and at least one publisher having a specified relationship with the advertiser; receive an offer from an advertiser specifying terms for placing a print ad in a publication of one or more of the publishers on the list, where the advertiser is inhibited from placing the print ad with the at least one publisher having the specified relationship with the advertiser; receive an acceptance from the publisher; receive print ad content from the advertiser and providing the print ad content to the publisher; and/or inhibit selection of at least one publisher on the list with the specified relationship with the advertiser. The presentation module 104b can present to the advertiser the list of identified publishers and/or present indicia identifying one or more publishers with which the advertiser has a specified relationship.

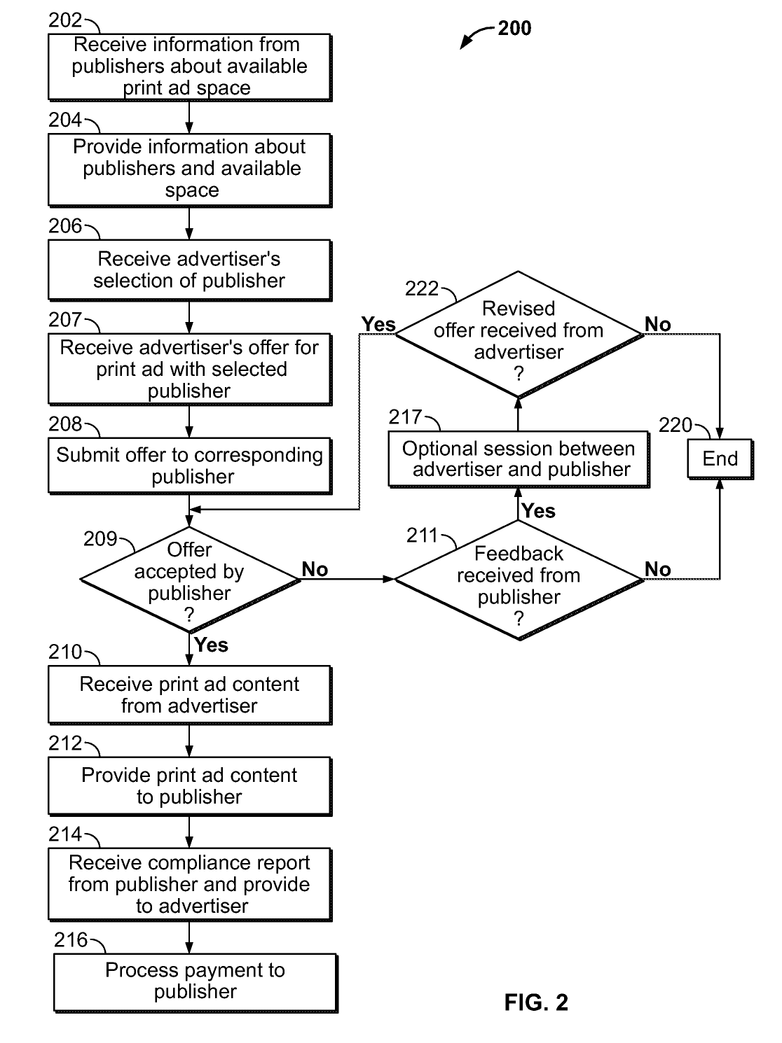

FIG. 2 is a flowchart showing an example process 200 for providing an electronic advertising system 100 (e.g., an online marketplace) for publishers 106 and advertisers 104, wherein one or more of the steps in the process can be carried out by, for example, the advertising system manager 104. Available print ad space is identified (step 202). For example, the publishers 106 can provide information to the advertising system manager 104 about available print ad space. The publisher information can include the name of the publication, the date or dates the publication is published, the location of the print ad space within the publication, the size and layout of the print ad space, whether the print ad will be run in black and white, color or either, and/or other information the publisher desires to provide to market their available print ad space.

Information associated with the publishers of the available print ad space is provided to advertisers (Step 204). For example, the advertising system manager 104 can provide an online marketplace in which publisher information provided by the publishers 106 is made available to the advertisers 102. In one implementation, the online marketplace is a web site. In this implementation, an advertiser 102 can be presented with a graphical user interface (GUI) through which the advertiser 102 can input certain choices about publishers with whom they would like to place ads. For example, the GUI can include checkboxes, drop-down menus, radio controls, data entry fields, and/or other user input controls or combinations thereof. In one implementation, the web site includes search capabilities. For example, if an advertiser 102 would like to search for a newspaper in a particular geographic location, the advertiser 102 can use the search capabilities to identify one or more newspapers meeting the advertiser's 102 geographic criteria, although a search query can be based on different and/or other search criteria as well.

An advertiser selects one or more publishers that the advertiser is interested in placing a print ad with (step 206). For example, using the web site provided by the advertising system manager 104, the advertiser 102 can provide input to the advertising system manager to choose one or more publishers 106 that the advertiser 102 is interested in placing ads with based on publisher information included on the web site. By way of illustrative example, consider an advertiser 102 that is interested in placing a print ad in a newspaper. In this example the publishers 106 are newspapers. The advertiser 102 can choose certain newspaper publishers 106, for example, based on factors such as geography, circulation size, ad size availability, section availability and other criteria. To the extent that a publisher 106 has provided publisher information relevant to these factors to the advertising system manager 104, the advertiser 102 has access to this information, through the advertising system manager 104, when choosing the newspaper publishers 106.

The advertiser creates an offer for one or more print ads with the selected publishers (step 207) and can submit the offer to the advertising system manager. The offer can include the specific terms associated with the advertisement including the price that the advertiser is willing to pay for placing the ad. For example, the advertiser 102 can select various parameters related to the desired advertising, such as the day(s)-of-week, desired newspaper section and ad size for each chosen newspaper publisher 106. The advertiser 102 can input a “bid amount” (e.g., a price the advertiser 102 is willing to pay to place an ad of the selected ad size in the chosen newspaper section on the selected day or days of the week). The advertiser's input, including the bid amount, can constitute the advertiser's “offer”.

In step 208, offers are submitted to corresponding publishers. For example, the advertising system manager 104 can submit the advertiser's offers to the corresponding publishers 106. In some implementations, submitting the offers can include sending an electronic message to the publishers that includes information about the offers. In some implementations, submitting the offers can include making the information about the offers available on a portion of a web site maintained by the advertising system manager 104, which may be accessible only to appropriate publishers. In some implementations, submitting the offers can include making the offers available on a particular portion of the web site and notifying the appropriate publishers of the availability of the offers by electronic message. Each publisher 106 can respond by either accepting or declining the offer. In one implementation, a publisher 106 can decline an offer but initiate an online (or offline) dialog with the advertiser 102 as to why the offer was not accepted and the two parties can attempt to reach an agreement satisfactory to both parties.

If an offer is accepted (“Yes” branch of decision step 209), the print ad content can be submitted (step 210). For example, the advertiser 102 can electronically submit corresponding print ad content to the publisher 106. Alternatively, the advertiser can supply print ad content with the offer. In one implementation, the advertiser 102 uploads an electronic file including the print ad content to the advertising system manager 104 and the advertising system manager 104 provides the electronic file to the publisher 106 (step 212).

If an offer is declined (“No” branch of decision step 209), a check can be made to determine if publisher feedback has been received (step 211). If so (“Yes” branch of decision step 211), an optional session between the advertiser and publisher can be initiated (step 216), during which, for example, the advertiser and publisher can continue negotiating terms associated with an ad placement. If no publisher feedback has been received (“No” branch of decision step 211), the process 200 can terminate (step 220). For example, if the publisher provides no comments or feedback to the advertiser 102 as to why the offer was declined, then the process terminates. However, if the publisher 106 does provide feedback to the advertiser 102, the advertiser 102 may be motivated to provide a revised offer (“Yes” branch of decision step 222), and the process returns to decision step 208. Otherwise, if the advertiser 102 does not provide a revised offer (“No” branch of decision step 222), the process terminates (Step 220).

Step 214 includes submission of a compliance report (e.g., an electronic tearsheet). For example, once the publisher 106 has run the ad (e.g., run the ad in the desired section in the newspaper on the selected date), the publisher 106 can provide proof that the ad ran to the advertising system manager 104. In one implementation, an electronic tearsheet can be uploaded to the electronic advertising system as proof that the ad ran according to agreed-upon terms. The electronic tearsheet can be an electronic file that includes an image of the ad as placed within the publication and can include enough information to show that the ad ran in the desired section of the newspaper on the selected date and according to any other specifications of the advertiser, e.g., ad size, ad color, font size, etc. In one implementation, the electronic tearsheet is a PDF file including a scanned representation of the page of the publication on which the ad ran.

Once an electronic tearsheet is uploaded by the publisher 106 to the advertising system manager 104, the advertising system manager 104 can provide the electronic tearsheet to the advertiser 102. For example, the advertising system manager 104 can forward the electronic tearsheet to the publisher by electronic message, by making the electronic tearsheet accessible in a portion of a web site to which the publisher has access, through a combination of providing access and sending an electronic messages, etc.

Once the advertising system manager 104 determines that the ad ran (e.g., by receiving an electronic tearsheet), the advertising system manager 104 can collect a bid amount from the advertiser 102 and transmit a publisher's share of the collected bid amount to the publisher 106 (Step 216).

In some implementations, an advertiser 102 can challenge the compliance report, i.e., the electronic tearsheet, within a specified period of time after the electronic tearsheet is uploaded. In particular, the advertiser 102 can, in some implementations, send a challenge message to the advertising system manager 104. The advertising system manager 104 may forward the message to the publisher 106, or the advertising system manager 104 may resolve any challenge raised by the advertiser directly (e.g., in an automated manner, or with human involvement, or with a combination of both). In some implementations, if it is determined that the ad was not run according to agreed-upon parameters, the bid amount may not be collected from the advertiser 102, and neither the advertising system manager 104 nor the publisher 106 may receive payment. A process for challenging a compliance report is described in further detail in U.S. patent application Ser. No. 11/753,407, entitled “Processing Electronic Tearsheets”, filed by Leader on May 24, 2007, the entire contents of which are hereby incorporated herein by reference.

In some implementations, the advertising system manager 104 automates many if not all steps in the process of either placing ads (e.g., steps taken by an advertiser 102) or selling ad space (e.g., steps taken by a publisher 106). For example, the advertising system manager 104 can automatically provide matches between advertisers 102 and publishers 106 based on their respective inputs (e.g., the advertisers' offers and the publishers' information). Further, the advertisers 102 can be provided with an electronic mechanism for uploading and transmitting the ad content to the publishers 106. The publishers 106 can be provided with an electronic mechanism for proving the ad was placed as agreed (e.g., in the form of an electronic tearsheet). Once both parties are satisfied their terms of the agreement (subject in some implementations to mediation by the advertising system manager 104), payment (e.g., the bid amount) can be automatically collected from the advertiser 102 and the publisher can be provided with the publisher's share of the bid amount.

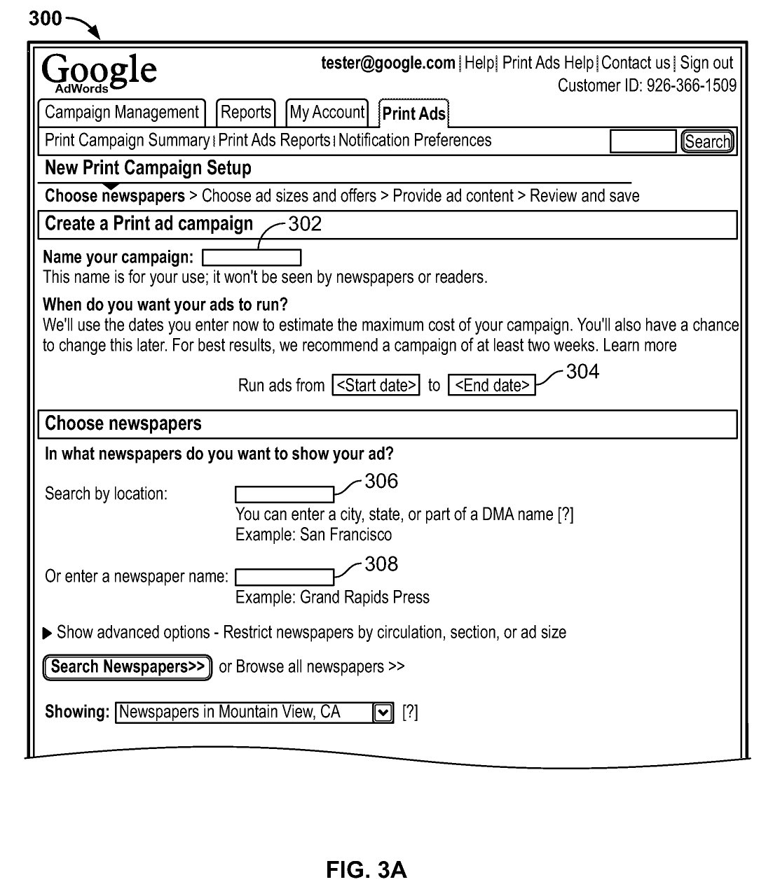

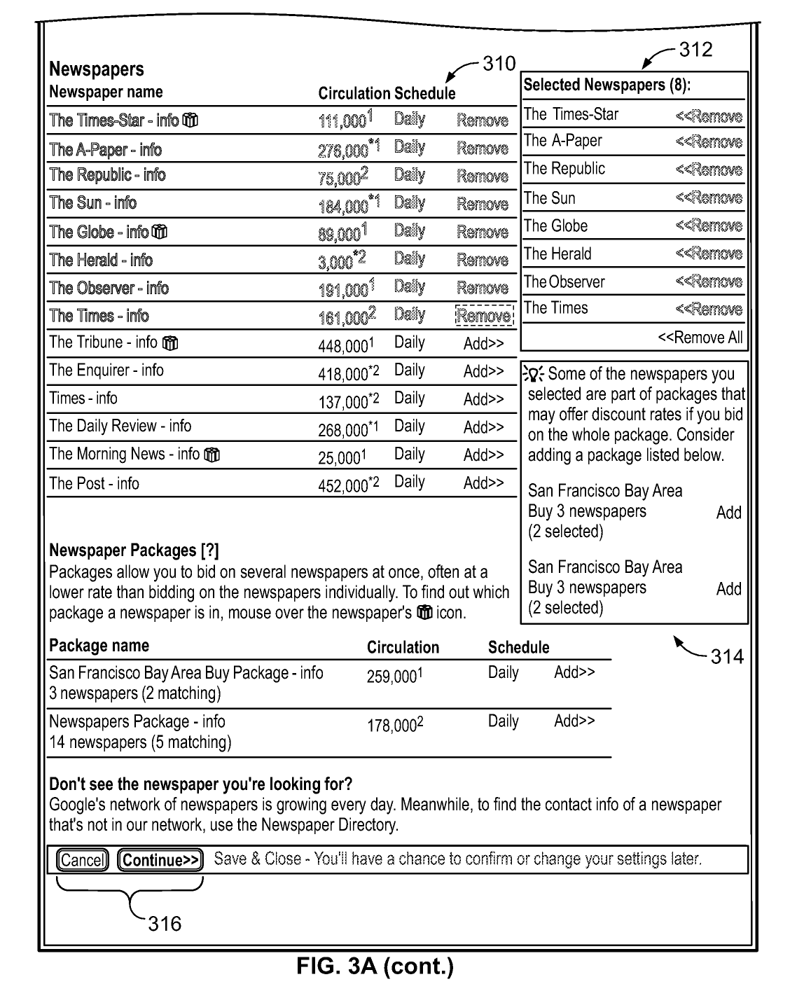

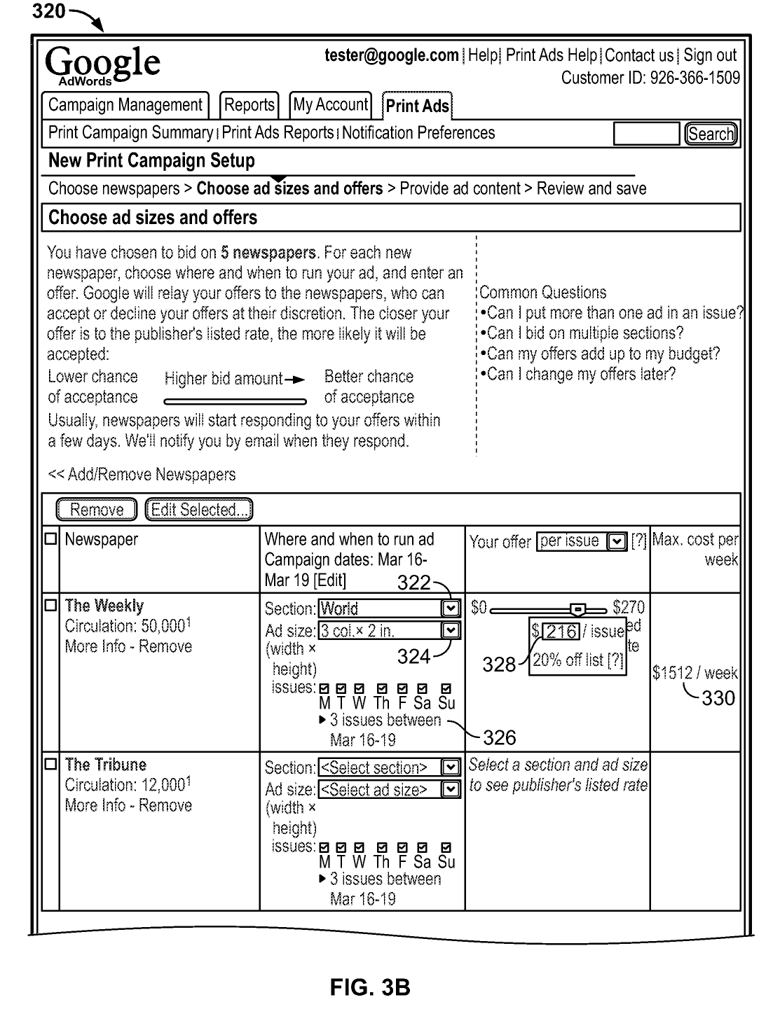

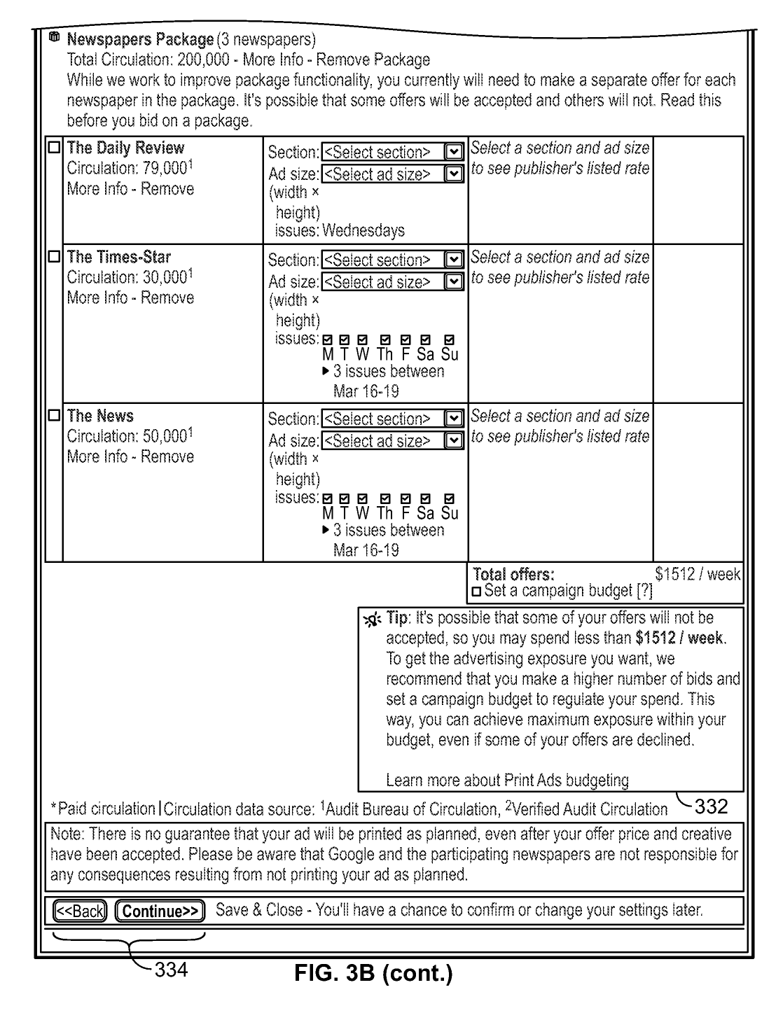

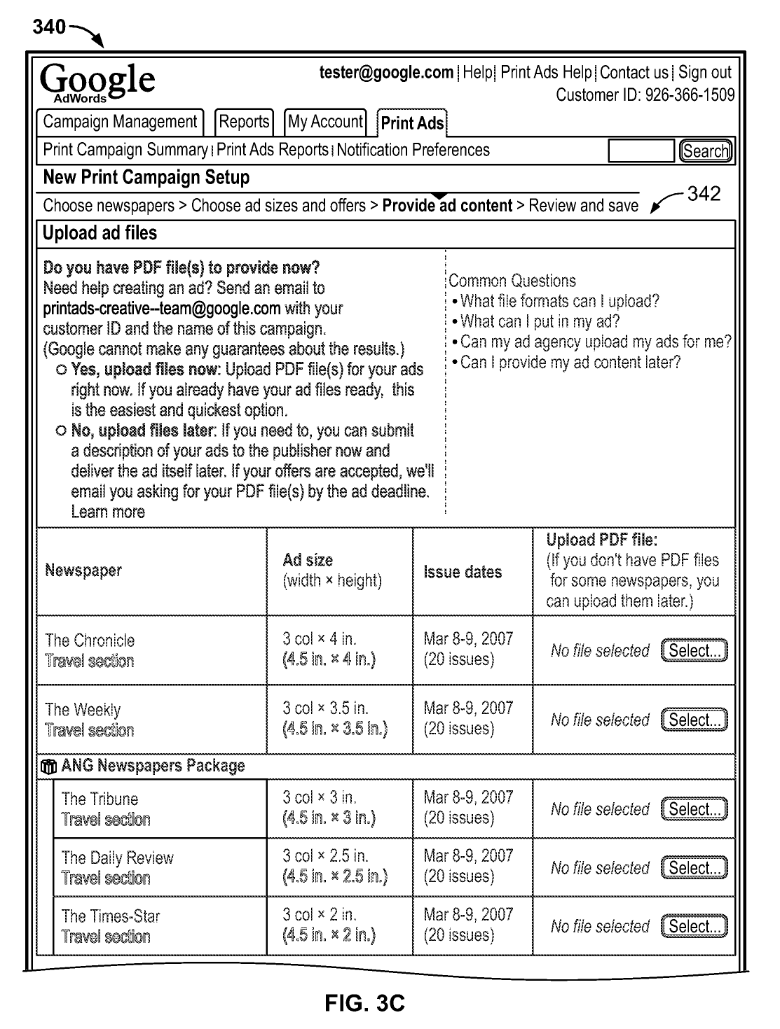

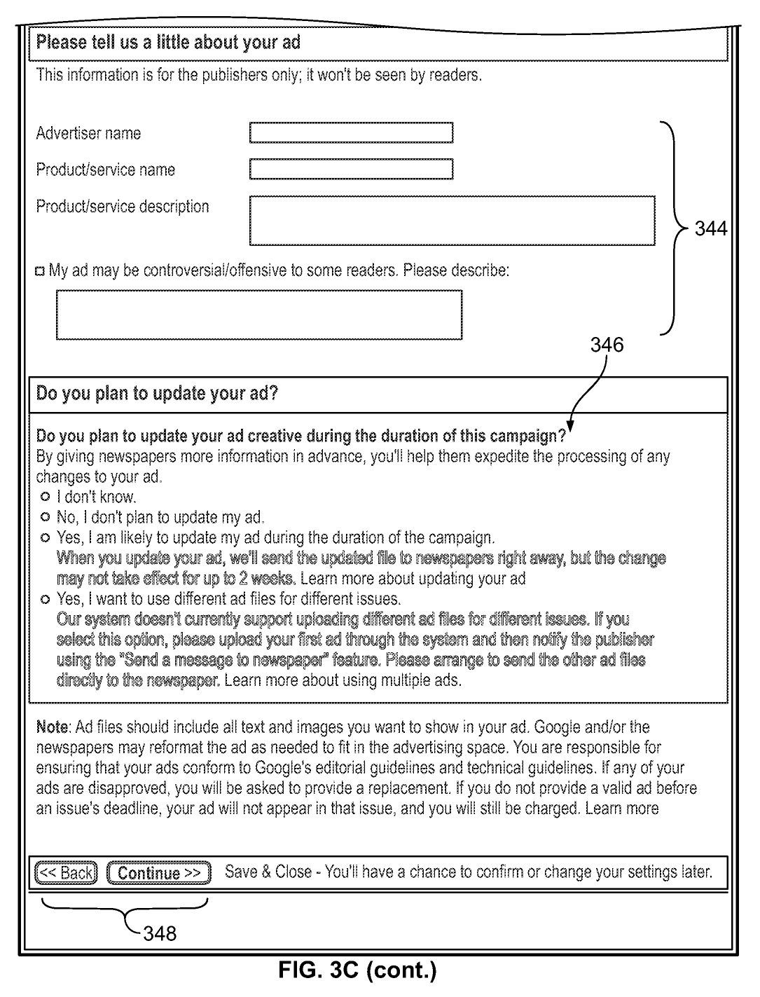

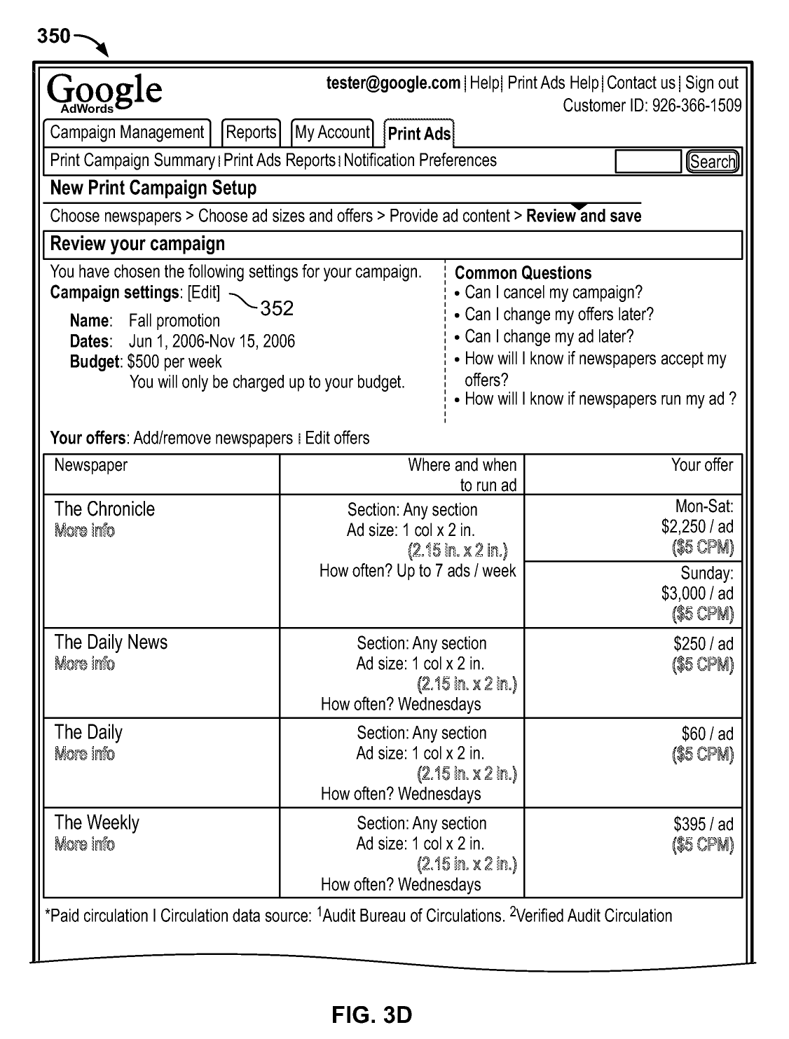

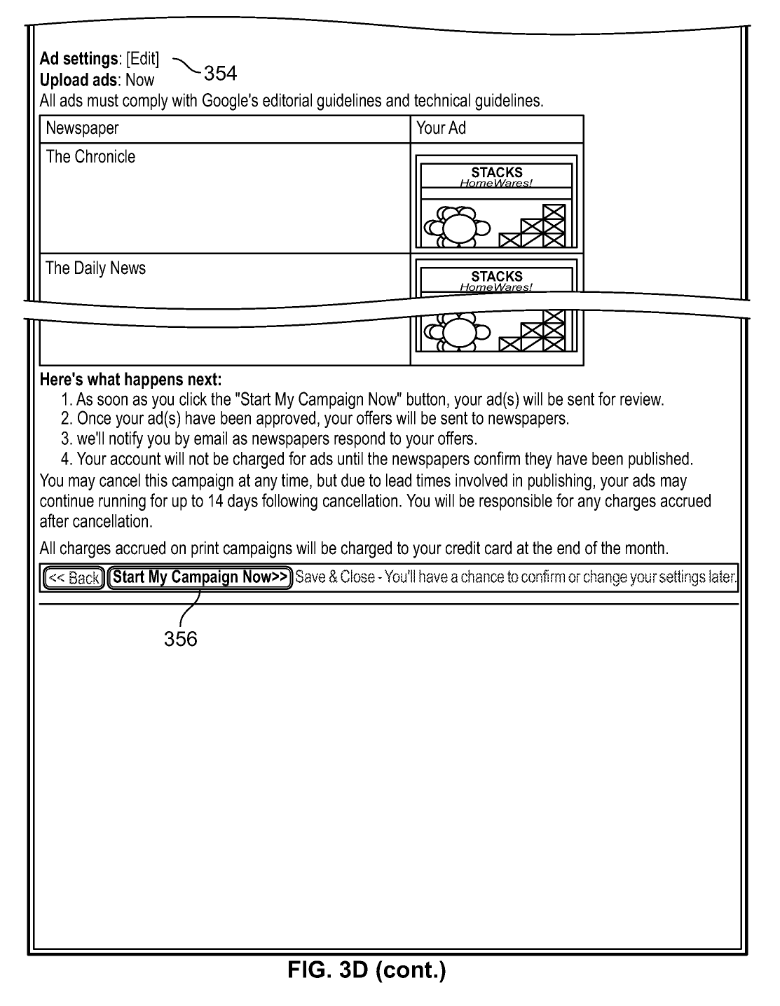

Advantageously, the advertiser 102 is provided with a central mechanism (e.g., the advertising system manager's website) to access available print ad space of, for example, multiple publishers. Correspondingly, the publishers 106 can be provided with a marketplace for their available print ad space. The payment mechanism (e.g., a bid system) can enable the advertiser 102 to only pay what the advertiser 102 decides to pay, and the publisher 106 can choose to accept only offers that are most desirous to the publisher 106. Referring now to FIGS. 3A-D, example GUIs of an example web site configured to implement the electronic advertising system provided by the advertising system manager 104 are shown. The GUIs shown in these figures are directed to the advertisers 102 and can be used to receive the advertisers' offers. These GUIs are illustrative examples, and other configurations can be used.

Referring particularly to FIG. 3A, a GUI 300 is shown for one particular example whereby an advertiser 102 is creating offers to place print ads with newspaper publishers 106. Data fields 302 and 304 are provided wherein the advertiser 102 can input a name for a print ad campaign being created (i.e., a set of offers) and the desired start and end dates for the ad campaign.

The advertiser 102 can choose to either search for names of newspapers by location using the search input field 306, or can enter a newspaper name into the data field 308. Other controls are provided for the advertiser 102 to search, for example, newspapers per the search criteria entered in the data fields, or by use of a drop down menu. A list of newspapers is provided to the advertiser 102, and in this example, the advertiser 102 has selected the first eight newspapers from the list 310. A data box 312 shown to the right of the list clearly identifies for the advertiser 102 the names of the newspapers selected and includes a “remove” control, whereby the advertiser 102 can select to remove one or more from the list. A second data box 314 provides additional information to the advertiser 102 about certain of the selected newspapers. The advertiser 102 is notified that some of the newspapers selected are a part of packages that offer discount rates if the advertiser bids on the whole package. Suggested packages to add to the list of selected newspapers are proposed to the advertiser 102. Near the bottom of the GUI 300 control buttons 316 are provided for the advertiser 102 to cancel or continue with inputting information to create offers. In this example, the advertiser 102 selects to continue.

Referring now to FIG. 3B, a next GUI 320 is shown that is presented to the advertiser 102 upon selecting to continue, as described above. Each of the newspapers selected by the advertiser 102 using the previous GUI 300 is listed beside a set of user controls. The advertiser 102 can employ the user controls to input specifics about their offer for each particular publisher 106, i.e., newspaper. In this implementation, the advertiser 102 is prompted to input the section 322 of the newspaper in which to run the print ad, the ad size 324, and the issues 326 (i.e., for a daily publication, the day(s) of the week). The advertiser 102 is also prompted to input a bid amount 328. A column to the right of the bid amount shows a calculated maximum weekly cost 330, based on the bid amount and the number of days selected.

A data box 332 can include multiple pieces of information. In this implementation, the data box 332 includes information about “overbidding”, a practice that can ensure advertisers get full use of their advertising budget. Because one or more of the advertiser's offers may not be accepted by publishers, the advertiser is recommended to create offers having a total bid amount greater than the advertiser's desired maximum weekly budget. However, only the first publishers that accept the advertiser's pending offers may secure the potential business with the advertiser. That is, a first publisher to respond to the advertiser's offers will likely be able to accept some or all of the advertiser's offers before the advertiser's maximum weekly budget is met. A last publisher to respond may not be able to accept any offers, if the advertiser's maximum weekly budget is already met by the earlier acceptance of offers by other publishers. A natural by-product of overbidding is a tacit incentive for publishers to respond quickly to advertisers offers and to minimize negotiating with advertisers, as a delay in acceptance due to negotiations can mean the offer will not longer be open for acceptance.

Control buttons 334 allow the advertiser 102 to go back to the previous GUI 300, continue or “save and close”. In this example, the advertiser 102 chooses to continue and is presented with the GUI 340 shown in FIG. 3C. The advertiser 102 can use the GUI 340 to upload files including the print ad content the advertiser 102 desires to place in one or more of the selected newspapers. In this implementation, data fields 342 are provided wherein the advertiser 102 can provide information for the publishers 106, including the advertiser's name, product/service name, product/service description, and a description of persons who may find the ad content controversial or offensive. Controls 346 are provided for the advertiser 102 to indicate whether they plan to update their ad and/or use different ad files for different issues. For example, the advertiser 102 may upload one ad file for use in issues published from Monday to Friday and a second ad file for use in issues published on the weekend. Controls 348 allow the advertiser 102 to go back to the previous GUI 320, continue or save and close.

In this example, the advertiser 102 chooses to continue and is presented with the GUI 350 shown in FIG. 3D. The advertiser 102 is presented with a summary of the ad campaign the advertiser 102 has created, including a summary of the advertiser's offers and the ad content uploaded in the ad files. The advertiser 102 can select “edit” controls 352 and 354 to edit the advertiser's offers and ad content. If the advertiser 102 is satisfied with the ad campaign as shown, the advertiser 102 can select the “start my campaign now” button 356 to initiate consideration of the offers by the corresponding publishers 106. In this implementation, the advertiser 102 is notified by email from the advertising system manager 104 as newspaper publishers 106 respond to the advertiser's offers.

In one implementation, an “in progress” campaign is saved automatically. For example, if an advertiser navigates away from the summary review page without selecting “Start My Campaign Now”, the campaign information input by the advertiser is saved. The advertising system manager 104 may be automatically alerted to have a salesperson follow-up with the advertiser to determine whether the advertiser has questions or concerns or would like to activate their ad campaign.

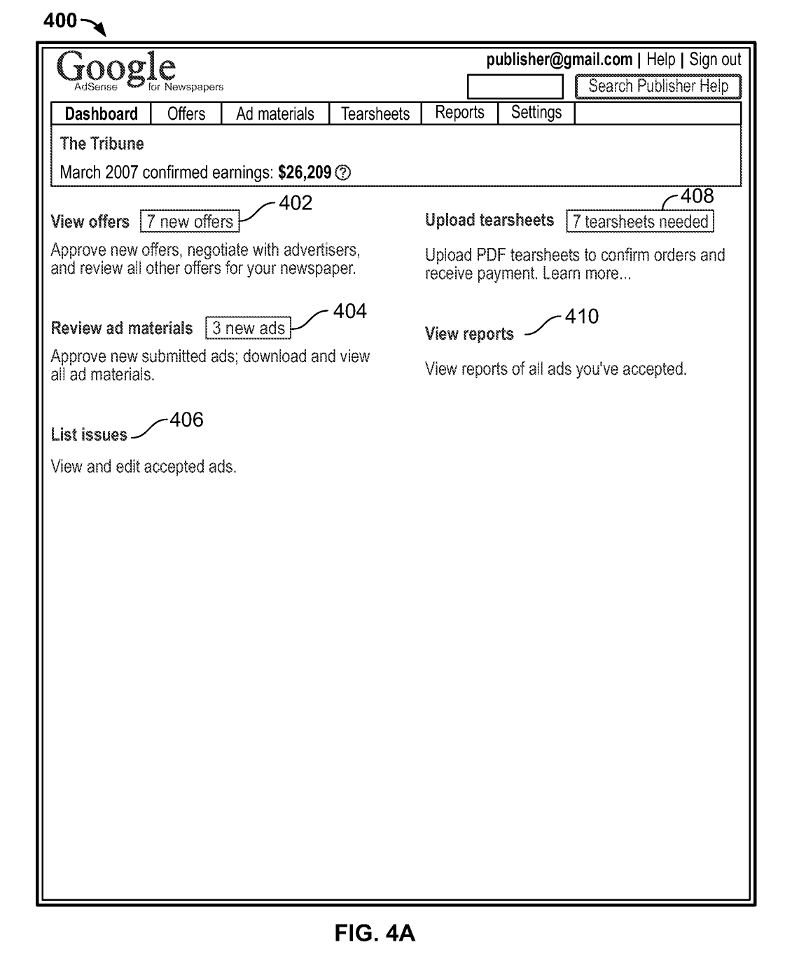

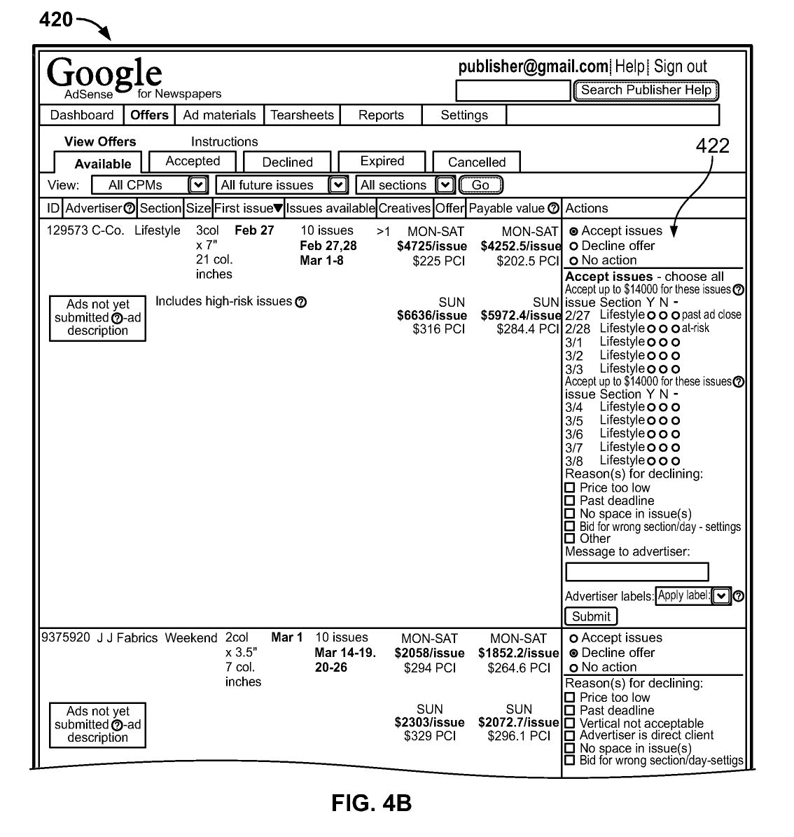

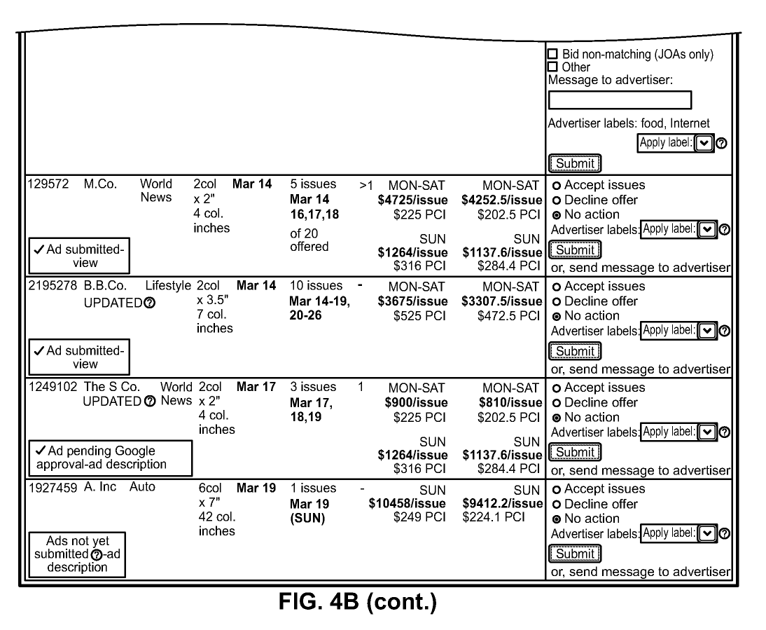

Referring now to FIGS. 4A-B, example GUIs directed to the publishers 106 are shown. These GUIs are illustrative examples, and other configurations can be used. FIG. 4A shows a GUI 400 including example content directed to a specific publisher 106, in this example, The Tribune. The publisher 106 is provided a summary of offers received 402, e.g., “7 new offers”, and provided a link to another web page to view the offers (see FIG. 4B). The publisher 106 is provided a summary of ad materials for review 404, e.g., “3 new ads” and a link to download and view the ad materials. A link to a list of issues 406 is provided to view and edit accepted ads. A summary of tearsheets needed is provided 408, e.g., “7 tearsheets needed”, and a link to upload a PDF tearsheet. A link to viewing reports 410 is provided, whereby the publisher 106 can view reports of all ads the publisher 106 has accepted. In this implementation, the publisher 106 can click on a button to view a list of offers received to place print ads in the publisher's publication.

Referring to FIG. 4B, a GUI 420 is shown that is presented upon the advertiser 102 clicking the view offers 402 link shown in FIG. 4A. Each offer received is detailed and an action column 422 is provided. The publisher 106 can input selections into controls and data fields included in the action column 422 to accept an offer, decline an offer and/or to provide reasons for declining an offer and an optional message to the advertiser 102.

As described above, once the publisher 106 proves the ad was placed as per the terms agreed to between the publisher 106 and the advertiser 102, the advertising system manager 104 automatically collects the bid amount from the advertiser 102. For example, in one implementation, the advertising system manager 104 automatically charges the bid amount to an account the advertiser 102 has with the advertising system manager 104. The advertising system manager 104 then transmits the publisher's share of the bid amount to the publisher 106 (e.g., credits the publisher's account) and retains the balance as payment to the advertising system manager 104. For example, in one implementation, the publisher's share is 85% of the bid amount. However, it should be understand a different percent or a different manner of calculating the publisher's share can be used and this is but one example.

Because payment to both the advertising system manager 104 and the publisher 106 does not occur until the publisher 106 has proved the ad has been placed, for example, by uploading an electronic tearsheet, the sooner the electronic tearsheet is uploaded, the sooner the bid amount can be collected. To encourage the publisher 106 to promptly upload the electronic tearsheet, the amount of the publisher's share can be made contingent on when the electronic tearsheet is uploaded. That is, if the electronic tearsheet is uploaded within a first period of time after the ad is placed, then the publisher's share includes a base amount and a first bonus. By way of illustrative example, if the electronic tearsheet is uploaded within 24 hours of the ad being placed, then the publisher's share includes a base amount of 85% of the bid amount and a first bonus of 5% of the bid amount.

In another implementation, different bonus amounts can be provided for different upload periods. For example, if the electronic tearsheet is not uploaded within the first period of time, but is uploaded within a second period of time, then the publisher's share includes a base amount and a second bonus, where the second bonus is less than the first bonus. By way of illustration, using the example from above, if the electronic tearsheet is uploaded after 24 hours but before 48 hours of the ad being placed, then the publisher's share increases from 85% to 88% of the bid amount, i.e., a 3% second bonus.

In another implementation, if the electronic tearsheet is not uploaded within a final period of time, then no payment is collected from the advertiser 102 and neither the advertising system manager 104 nor the publisher 106 get paid for the ad, even if the ad was placed according to the terms agreed to by the publisher 106 and the advertiser 102.

In the above example, the publishers performance is monitored based on the time it takes a publisher to upload an electronic tearsheet. However, in other implementations, different factors can be monitored as indications of good performance. For example, other performance factors can include: time to respond to new offers; placement quality of print ads; percentage of print ad placements that are correctly executed; an advertiser satisfaction rating of interaction with the publisher and/or publisher ad performance. Rating the publishers performance based on one or more of the above factors, or other factors, can be systematic and automated, can be advertiser-specified or can be qualitatively judged by the advertising system manager 104.

### Publisher Blacklist

In some implementations, a publisher may wish to inhibit specified advertisers from submitting offers through the advertisement system manager to place ads with the publisher and would prefer to transact directly with such advertisers. For example, if the publisher has a pre-existing business relationship with the advertiser and has previously placed one or more ads on behalf of the advertiser, the publisher may prefer to carry on business with that advertiser outside of the electronic print ad management system 100. The advertiser may not, however, have a previous advertising relationship with other publishers using the system 100. Accordingly, excluding the advertiser from the system 100 altogether may not be a suitable solution. Accordingly, to allow both the publisher and the advertiser to use the system 100, just not to transact with one another, the advertiser can be inhibited from placing print ads with the publisher through the system 100, although be able to place print ads with other publishers through the system. In effect, the publisher “blacklists” certain advertiser with whom the publisher has a specified relationship, usually a pre-existing advertising relationship although other criteria can be employed.

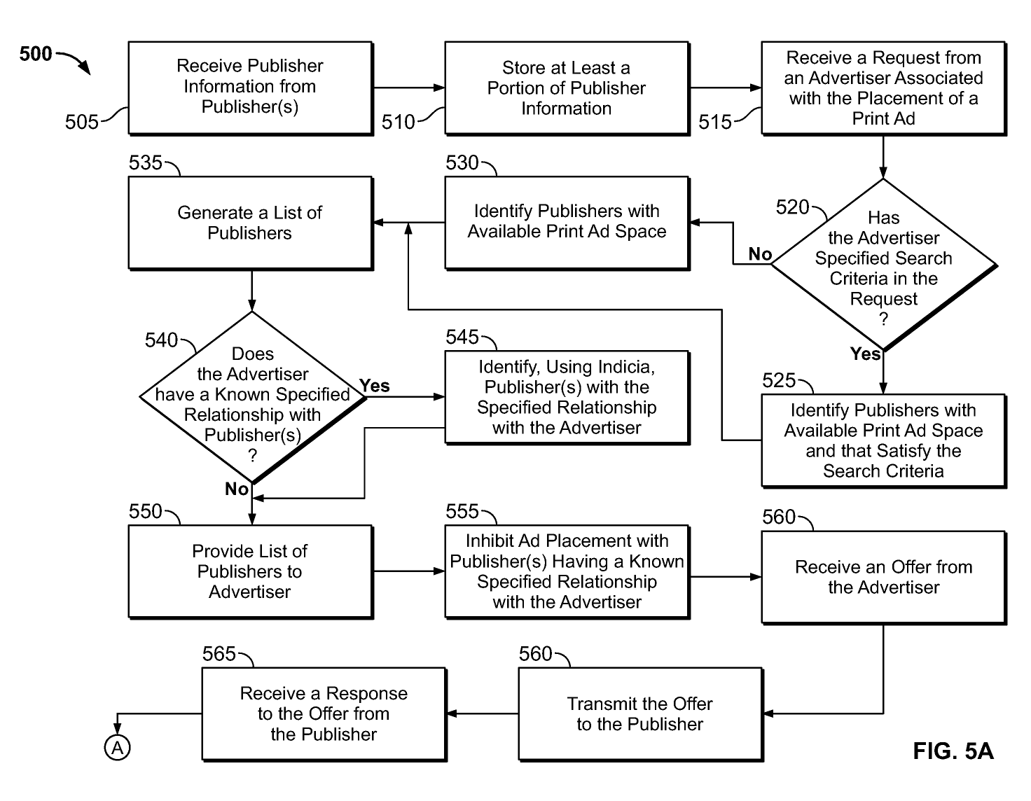

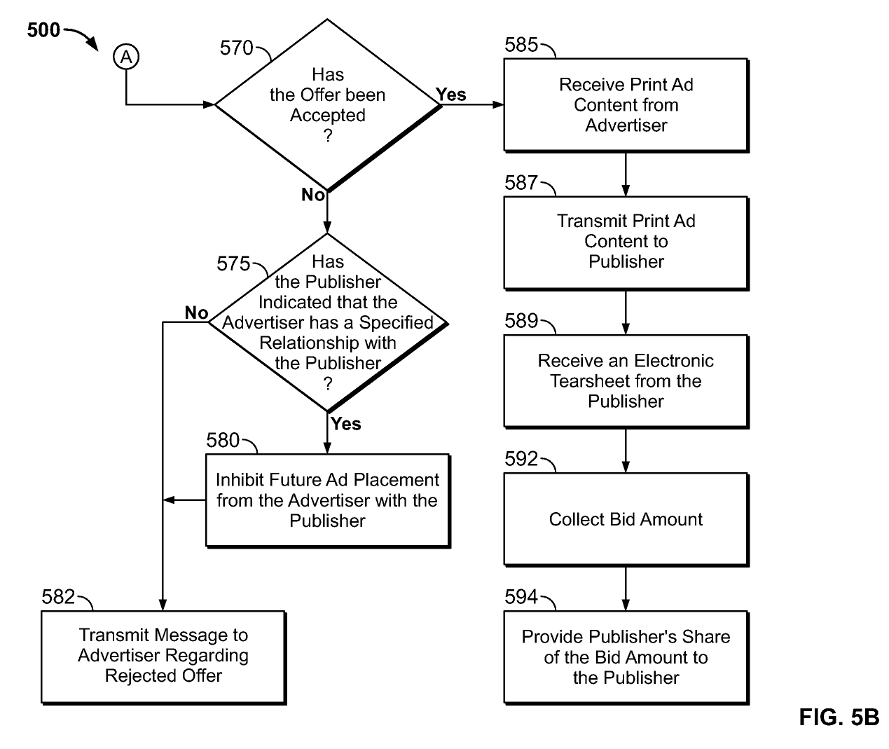

FIG. 5A illustrates a process 500 for managing print ad placement. Publisher information is received from one or more publishers (Step 505). For example, referring to the electronic print ad management system 100, the publishers 106 can transmit over the network 110 publisher information to the advertisement system manager 104. The advertisement system manager 104 can provide an interface to facilitate receipt of the publisher information. The publisher information can include information about available print ad space in the publisher's publication(s). In one implementation, the publisher information can include information about advertisers that have a specified relationship (e.g., previous advertising relationship) with the publisher, i.e., the publisher's blacklist.

The publisher information (or at least a portion thereof) can be stored (Step 510). For example, after the advertisement system manager 104 receives the publisher information, the publisher information can be stored on a memory coupled to the advertising system manager 104.

A request can be received from an advertiser associated with the placement of a print ad (Step 515). The request can be received through an interface provided by the advertisement system manager. The interface can include fields that facilitate the receipt of requests allowing requests to be received in a uniform and consistent format. Increasing the uniformity and consistency of the requests can facilitate analysis of offers by a publisher, as similar offers may be more easily compared.

If the advertiser has specified the search criteria in the request (“Yes” branch of decision step 520), then publishers with available print ad space that satisfy the search criteria are identified (Step 522). Otherwise, publishers with available print ad space are identified (Step 530). For example, an advertiser 102 may specify search criteria related to the print ad requested, such as geographical location of publication, type of publication (e.g., newspaper, online provider, magazine, etc.), length of print ad, etc. An interface generated by the advertisement system manager 104 can facilitate entry of search criteria by the advertiser 102. For example, the interface can allow an advertiser to select search criteria from available options.

If search criteria has been specified, in one example the advertisement system manager can search a database including publisher information to identify publishers that have available print ad space and satisfy the search criteria. As another example, a listing of the publishers 106 available through the advertisement system manager 104 can be generated and then publisher information provided by the publishers can be analyzed to identify publishers that satisfy the search criteria.

A list of the publishers identified in either steps 525 or 530 is generated (Step 535). The list of publishers can include information, such as publisher name, type of publisher, attributes of print ad available (e.g., size, type, etc.), length of time ad space is available, and/or other appropriate information. In addition, a publisher may be included in a group of publishers (e.g., owned by a common company). In another example, a single publisher may provide a group of publications (e.g., owned by the publisher). The list of publishers may identify which publishers and/or which publications within a publisher have available print ad space.

A determination can be made as to whether the advertiser has a known specified relationship with one or more publishers included on the list (Step 540). A “known” specified relationship is a specified relationship that is known to the entity generating the list, for example, the advertising system manager 104. In one implementation, publisher information for the publishers with which offers for print ads may be placed through the advertisement system manager can be analyzed to determine if a specified relationship, such as a previous advertising relationship, exists with the advertiser. As another example, a determination may be made only with respect to the publishers on the list, as to whether one or more have a specified relationship with the advertiser. In one implementation, the “blacklist” of each publisher on the list is analyzed to determine whether the advertiser is included on the blacklist.

If the advertiser has a known specified relationship with one or more publishers, then these publishers can be identified with indicia (Step 545). Indicia can include, for example, an image, text (e.g., Not Available, Pre-existing Relationship, etc.), color, and/or highlighting. The indicia can be presented to an advertiser proximate a publisher name on the list. As another example, the name of a publisher on a list can be presented in a different color than other text and/or images on the list. Other forms of identification or exclusion can be used.

The list can be presented to the advertiser (Step 550). The list may be presented through an interface generated by the user. The interface may list at least a portion of publisher information, such as publisher name, available space, etc. The interface may allow an advertiser to control the display of the list, for example, by allowing the advertiser to sort the list and/or perform queries on the list.

Ad placement with publishers having a known specified relationship to the advertiser can be inhibited (Step 555). Publishers may inhibit offers from advertisers with a specified relationship, such as a previous advertising relationship, to separately manage advertisers with which the publisher has a direct relationship. However, the same advertiser may be allowed to provide offers to other publishers. In addition, a portion of the publishers with the specified relationship to the advertiser may elect to allow the advertiser to submit offers through the advertisement system manager.

Inhibiting ad placement with a particular publisher can include inhibiting selection of the publisher through an interface generated by the advertisement system manager. For example, the list may not include link (e.g., through which an offer may be submitted) for the publisher with the specified relationship. As another example, the list may present contact information for the publisher with the specified relationship when the publisher is selected by the advertiser, rather than presenting a link through which an offer may be submitted. The presentation of the contact information is to encourage to the advertiser to contact the publisher directly to place an ad with the publisher.

In another implementation, inhibiting ad placement comes further downstream in the process. That is, the advertiser is permitted to submit an offer to place an ad with the publisher, but the offer is automatically rejected by the publisher since the advertiser is on the publisher's blacklist.

Referring again to FIG. 5A, an offer can be received from the advertiser (Step 560). The offer can include offer terms or parameters, such as bid amount (e.g., amount the advertiser is willing to pay for placing the print ad), publication time, size of print ad requested, content of print ad (e.g., text, images, video, etc.). The advertisement system manager may generate an interface through which the offer is received. The interface may allow offer terms to be provided by the advertiser and transmitted to the advertisement system manager.

The offer is transmitted to the publisher (Step 560). For example, the advertisement system manager may transmit a message (e.g., email, XML message, etc.) to the publisher with the offer. As another example, the advertisement system manager presents the offer to the publisher through an interface. When the publisher accesses the advertisement system manager, the offer, other pending offers, previous offers, etc. may be presented on the interface. In one implementation, to inhibit ad placement with a publisher with whom the advertiser has a known specified relationship, the advertisement system manager can automatically reject the offer on behalf of the publisher, in which case the offer is not transmitted to the publisher.

A response to the offer can be received from the publisher (Step 565). For example, the publisher may accept, decline, and/or present a counteroffer to the offer provided by the advertiser. The response may be received through an interface generated by the advertisement system manager. The interface may present available options for responding to an offer, from which the publisher selects a response.

Referring now to FIG. 5B, if the offer is not accepted (“No” branch of decision step 570), a determination can be made as to whether the publisher has indicated that advertiser has a specified relationship with the publisher. That is, has the publisher rejected the offer and added the advertiser to the publisher's blacklist? If so, (“Yes” branch of decision step 575), then the advertiser will be inhibited from future ad placement with the publisher. For example, when an advertiser attempts to provide an offer with this publisher, the offer may be immediately rejected and a message may be provided to the user that indicates that the offer was not allowed through the system for this publisher. As another example, an offer may be inhibited by inhibiting selection of the publisher (e.g., graying out the publisher name, dead link, etc.) when an advertiser provides a requests related to print ads.

If that is not the case, i.e., the offer was rejected for other reasons (“No” branch of decision step 575), then the advertiser can be notified of the rejection (Step 582). For example, the message may be an email. The message may be presented through the interface generated by the advertisement system manager. The message may include reasons for the rejection provided by the publisher (e.g., specified relationship exists, price to low, space unavailable, etc.).

If an offer has been accepted (“Yes” branch of decision step 570), then print ad content may be received from the advertiser (Step 585). For example, the advertiser may email the print ad content to an address specified on the interface generated by the advertisement system manager. As another example, the advertiser may upload the print ad content to the advertisement system manager. The print ad content may include an electronic version of the advertisement the advertiser is requesting publication.

The print ad content can be transmitted to the publisher (Step 587). For example, the print ad content may be automatically downloaded to a predetermined memory by the advertisement system manager. As another example, a link to the print ad content may be provided through the interface generated by the advertisement system manager and the publisher may download the print ad content using the link. In addition, a message may be transmitted to the publisher with the print ad content.

After the publisher has placed the ad, an electronic tearsheet may be received from the publisher (Step 589). The electronic tearsheet can confirm placement at a placement time of the print ad in a publication according to the accepted offer terms.

A bid amount can be collected from the advertiser (Step 592). For example, the advertisement system manager may manage the receipt of, for example, a wire transfer or electronic fund transfer to an account (e.g., PayPal account, bank account, etc.) of the advertisement system manager from the advertiser. The publisher's share of the bid amount is provided to the publisher (Step 594). For example, the advertisement system manager may automatically electronically transfer at least a portion of the bid amount to the publisher. In addition, the advertisement system manager may automatically deduct the portion of the bid amount payable to the advertisement system manager for managing the transaction.

Process 500 can be implemented by example system 100 or similar systems. In addition, various operations may be added, deleted, modified, or reordered in process 500. For example, the publisher information may not be stored. As another example, the search criteria, list of publishers, offers, print ad content, and/or electronic tear sheet may be stored (e.g., on a memory of the advertisement system manager). In some implementations, publisher information may not include whether advertisers have a specified relationship, such as a previous advertising relationship, with the publisher. Specified relationships between advertisers and publishers may be identified when offers are presented to a publisher and subsequently rejected.

In addition, the advertisement system manager may allow the publisher to specify advertisers that have a specified relationship with the publisher through an interface generated by the advertisement system manager. For example, the interface may present a list of advertisers (e.g., that have used advertisement system manager, that have placed offers previously with the publisher and/or other publishers, etc.) to the publisher. The interface may allow the publisher to control the presentation of the list by, for example, allowing the publisher to sort and/or perform queries on the list. The publisher may select and/or otherwise provide (e.g., through a free-form text entry field) names of advertisers to designate as having the specified relationship. The publisher may also modify the designated relationship between the publisher and the advertiser. For example, the publisher can change the designation of a relationship from “a prior advertising relationship” exists to “no relationship”. In addition, a publisher may allow offers to be accepted from specified advertisers notwithstanding a specified relationship. For example, the publisher may receive frequent offers from a first advertiser and infrequent offers from a second advertiser. The publisher may allow offers through the advertisement system manager from the first advertiser, while inhibiting the second advertiser from providing offers through the advertisement system manager. As another example, the publisher may require (e.g., required by business rules, industry standards, or government regulations) a review of certain types of advertising prior to accepting an offer. The publisher may elect to designate these advertisers as having a specified relationship with the publisher to inhibit request for print ads through the advertisement system manager from these advertisers.

In addition, determining whether the advertiser has a specified relationship to the publisher can include retrieving a list of top advertisers in a geographical region and determining if the advertiser is on the list and the publisher is in the geographical region. For example, the top 10 advertisers in the United States (e.g., in terms of dollars spent on advertising in a year) may be listed in a database accessible by the advertisement system manager. The advertisement system manager may determine if the advertiser is on the list and then identify which publishers have distribution in the region specified (e.g., United States). The advertisement system manager may then designate these identified publishers as having a specified relationship with the advertiser, i.e, deem a specified relationship. However, in some implementations the publisher can elect to allow offers from an advertiser notwithstanding their being on the top advertiser list.

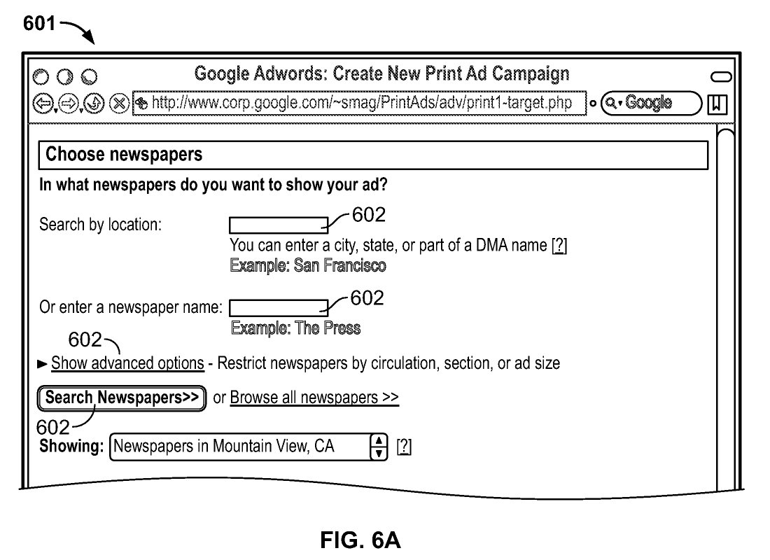

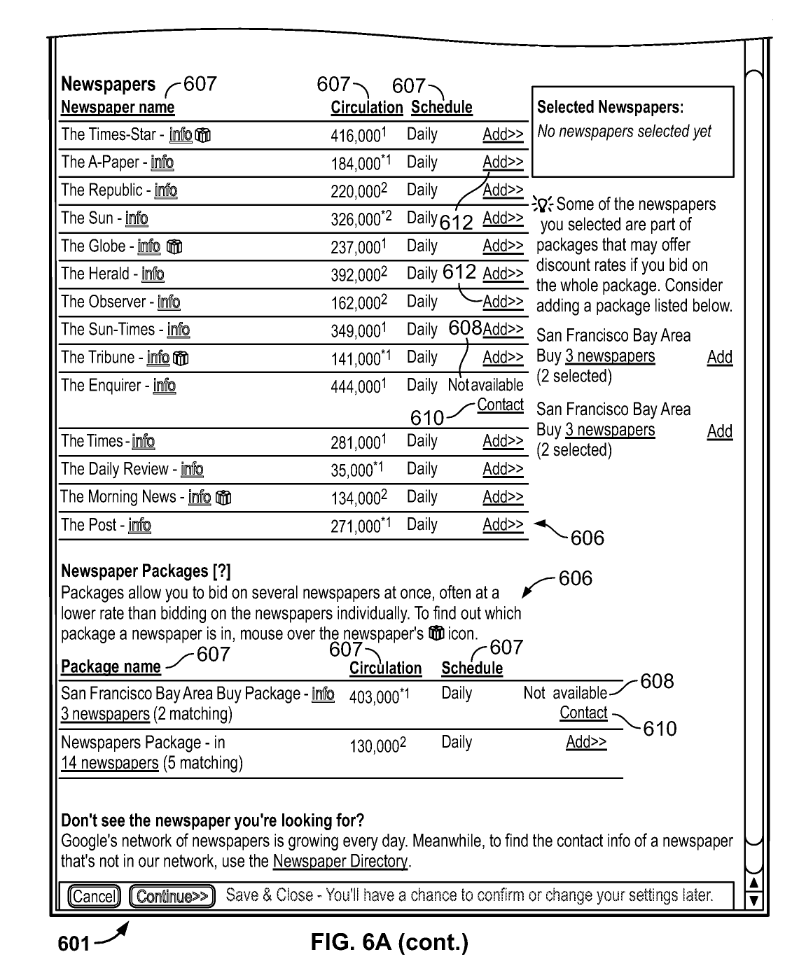

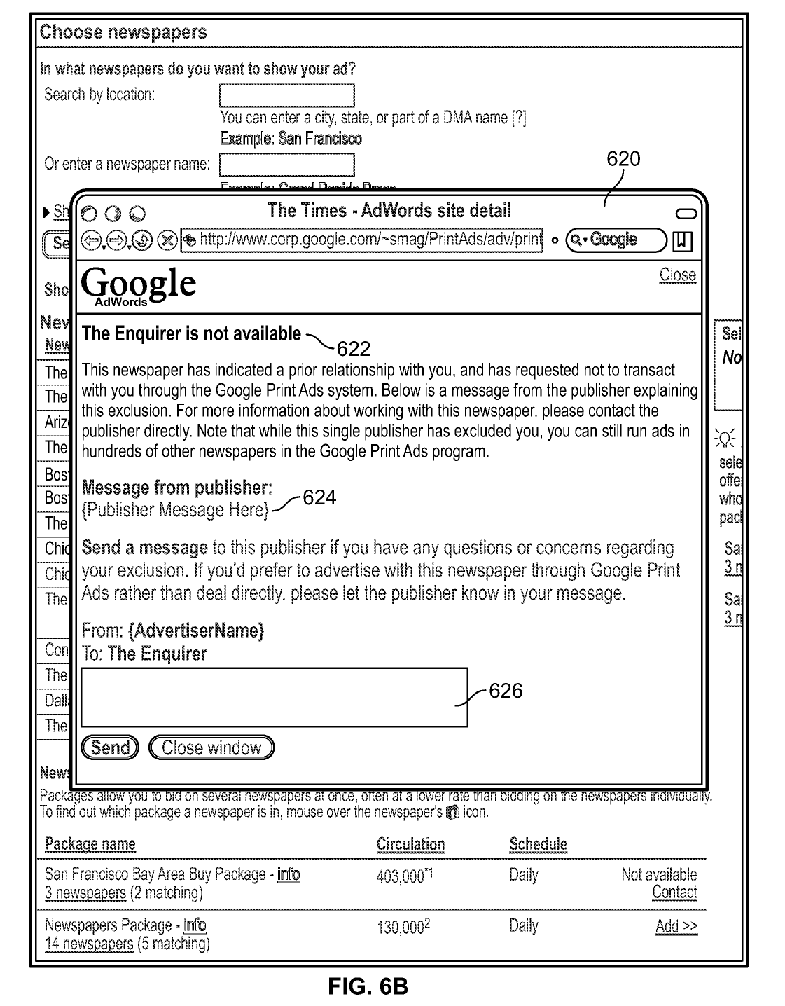

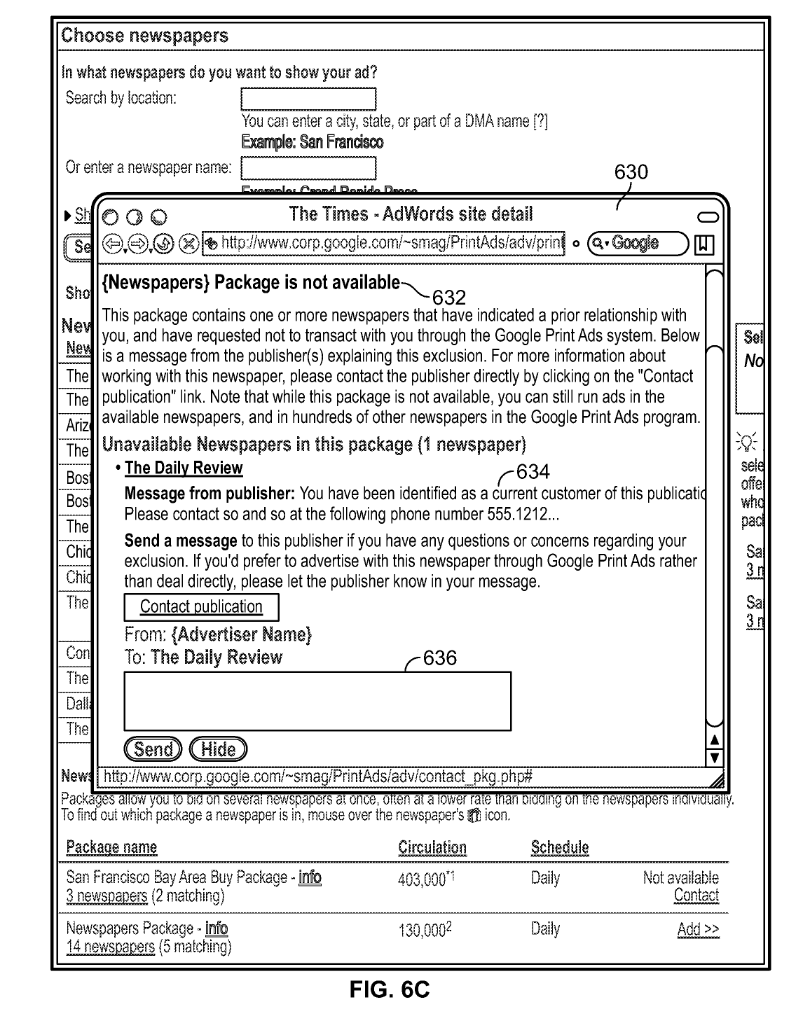

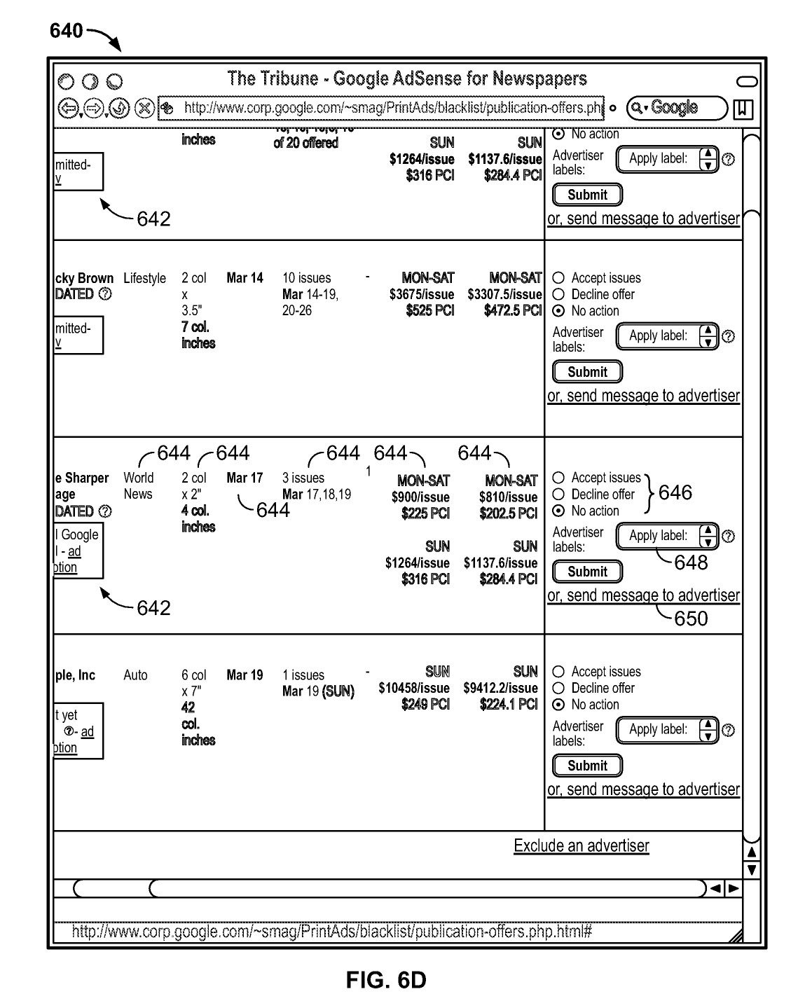

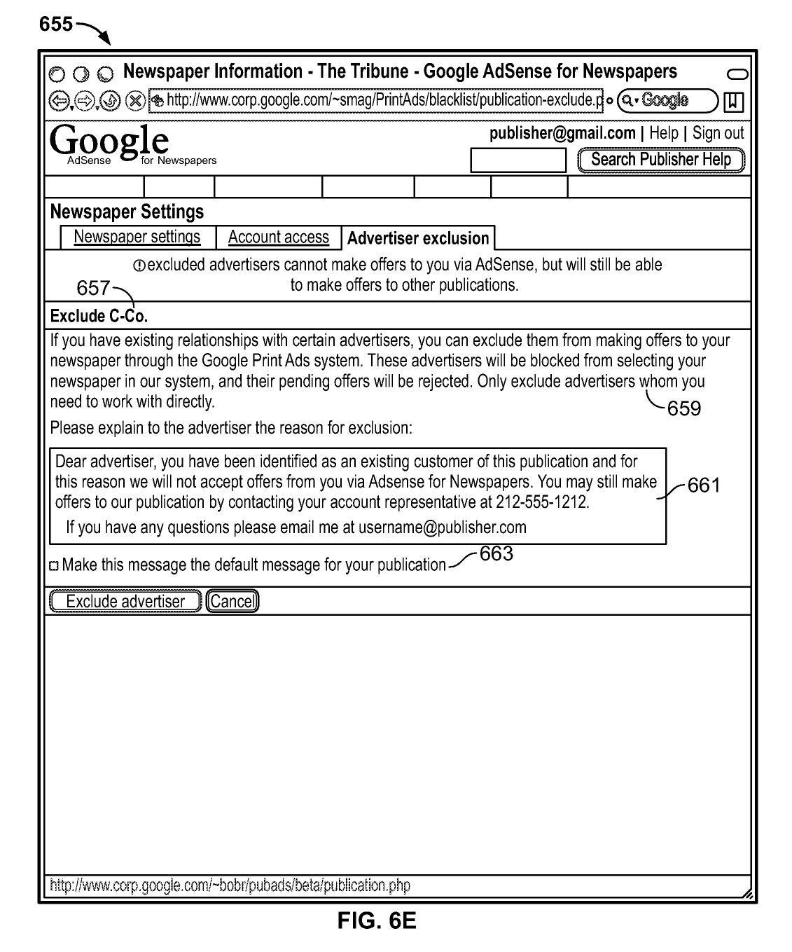

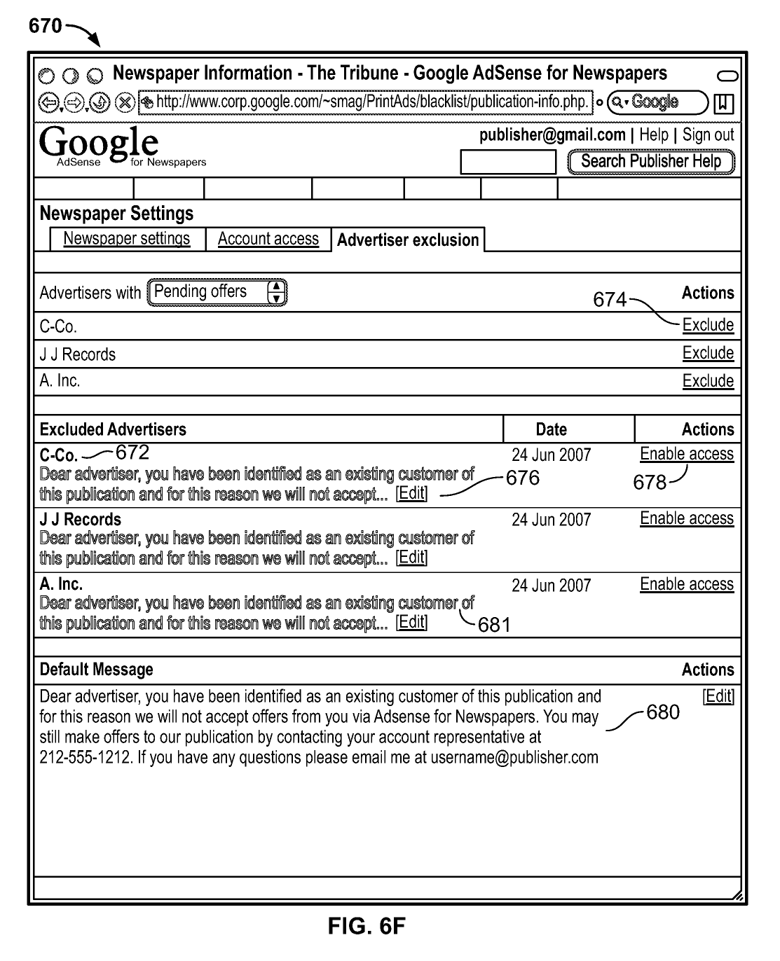

FIGS. 6A-F illustrate example interfaces generated by the advertisement system manager 104 as illustrated in system 100. An advertiser 102 may access the advertisement system manager 104 through, for example, a web site on the Internet as previously discussed above. In one example, the advertiser may log on to the system (e.g., by providing a user name and/or password) so that a customized interface (e.g., advertiser specific interface) may be presented to the user. The interface 601 may present, to the advertiser, fields 602 for the advertiser to enter search criteria such as publisher name, geographical location of publication, circulation, section, ad size, type of publication (e.g., newspaper), and/or other appropriate criteria, see FIG. 6A. The fields may be presented as fields that allow an advertiser to enter free-form text, drop-down fields, buttons, links, etc. The interface 601 also includes a link 604 that allows the advertiser to view all publishers and/or all publishers with available print ad space.

The results of application of the search criteria may be presented in a portion 606 of the interface 601. The portion 606 may include the name of the publisher, circulation, schedule, and/or other publisher information. The interface may allow presentation of the information in the portion 606 to be controlled, such as by allowing the information in the portion 606 to be sorted by publisher information categories 607. The portion 606 may also include indicia 608 to identify publishers with which the advertiser has a specified relationship. A link 610 which may present contact information in a separate window, for example, may be provided for publishers with the specified relationship to the advertiser. In addition, the interface 601 includes links 612, which may be selected by an advertiser, to provide an offer to the selected publisher.

FIG. 6B illustrates an example of the interface 620 presented when an offer is submitted for a publisher with which the advertiser has a specified relationship. The interface 620 may be a new window presented to the advertiser. The interface 620 includes messages, such as a message 622 of the specified relationship and/or messages from the publisher 624. The publisher using the interface may customize the message 624 from the publisher. For example, the same and/or different messages may be provided to advertisers with the same and/or different specified relationships.

In one implementation, an advertiser 102 can contest the designation of having a specified relationship with the publisher by contacting the publisher, such as by sending a message 626 to the publisher. The advertiser may also send other messages, such as questions, to the publisher via a messaging portion 626 on the interface.

In some implementations, placement of an ad may be selectively inhibited. For example, if a publisher has an available ad space and receives offers that the publisher finds unacceptable, then the publisher may allow placement of ads from one or more advertisers with the specified relationship with the publisher, who may or may not have been previously inhibited from placing ads with the publisher. The publisher may elect to temporarily, for a specified period of time, or until the published elects to reinstitute the inhibition, allow the placement of ads from these advertisers. The publisher may specify offer criteria (e.g., receive more than a particular number of offers, receive more than a specified number of offers over a specified amount, etc.) that when applied automatically inhibits placement of ads (e.g., temporarily) from advertisers with the specified relationship with the publisher and that have been previously inhibited from placing ads with the publisher. When the specified offer criteria is not satisfied, at least a portion of previously excluded advertisers (e.g., with the specified relationship) may be automatically allowed to place ads with the publisher.

FIG. 6C illustrates an example of the interface 630 presented when an offer is submitted for a publisher package in which the advertiser has a specified relationship with at least one of the publishers in the package. The interface 630 may present a message 632 regarding the specified relationship and/or an identification 634 of the publisher in the package with which the advertiser has the specified relationship. The interface may include a portion 636 through which messages may be sent to publishers of the package and/or with publishers that have been identified as having a specified relationship with the advertiser.

Once the advertiser has provided an offer with offer terms, such as the duration of the print ad, the publication time of the print ad, etc, the offer may be provided to the publisher. FIG. 6D illustrates an example of an interface presented to a publisher that includes offers. The interface 640 includes one or more offers 642 and/or offer terms 644. The interface 640 may also include available response options 646 to the offer by the publisher. As illustrated, the publisher may accept, waive, inhibit one time and accept at a later time, decline, or take no action. In addition, an indication or label of the relationship between the advertiser and the publisher may be provided through a field 648. The interface 640 may also allow messages from the publisher to the advertiser (e.g., requesting clarification of terms or print ad content, submitted counteroffer, etc.) to be transmitted by, as illustrated, selecting a button 650 on the interface. The interface 640 may include currently pending offers and/or past offers.

FIG. 6E illustrates an example of an interface 655 through which the publisher may indicate whether advertisers have a specified relationship with the publisher. The interface may present the name 657 of advertisers that have been identified as having a specified relationship (e.g., the publisher may identify them prior to or after receiving an offer). The interface 655 may present a message from the advertisement system manager relating to permissions of the identified advertisers. For example, the advertisement system manager may require that a previous advertising relationship existed for a specified period of time for identification of an advertiser as having a specified relationship. The interface 655 may also include a message that the advertiser will be presented if the advertiser attempts to provide an offer or provides an offer to the publisher (e.g., see message 624 presented in interface 620 in FIG. 6B). The interface 620 may also include a portion in which offer criteria may be provided by a publisher. When the offer criteria is satisfied, for example, offers from advertisers with a specified relationship with the publisher may be inhibited, and when offer criteria is not satisfied previously excluded advertisers may be allowed to place an ad with the publisher. For example, the publisher may include criteria such as inhibiting placement of ads from previously excluded advertisers when: greater than a specified number of ads are received for available ad space, an offer is received that includes a bid that is a specified percentage higher than the next higher bid, etc. The publisher may apply the criteria to all available ad space or to specified available ad space. The publisher may also select which advertiser(s), of the advertisers that are known to have a specified relationship with the publisher, will be allowed to place ads due to the criteria not being satisfied (e.g., failure to satisfy criteria may allow specified previously excluded advertisers to place ads while continuing to inhibit other previously excluded advertisers). The interface 655 may include a field 663 that allows the same message to be presented to other advertisers identified as having the specified relationship.

FIG. 6F illustrates an interface 670 in which three advertisers have been identified as having the specified relationship with a publisher. The interface 670 includes names 672 of advertisers that have been identified and a relationship status 674 (e.g., “excluded” from system for the publisher when offers from the advertiser will be inhibited to the publisher). The interface 670 may allow editing through a link 676 of the message automatically presented to the user when the user attempts to offer or provides an offers to the publisher. The interface also includes a link 678 to change the relationship status to allow advertisers (e.g., previously excluded) to submit offers through the advertisement system manager. The interface also presents the default message 680 presented to advertisers with which the publisher has a specified relationship, when these advertisers attempt to submit an offer and an advertiser specific message 681 has not been provided by the publisher.

It should be understood that although a publisher's “blacklist” has been referred to above, a list is not necessarily required per se. That is, as already discussed, in one implementation, a publisher can provide a blacklist to the advertising system manager and request that advertisers included on the list be inhibited from placing ads with the publisher through the advertising system manager. However, in another implementation, at a time when an advertiser submits an offer to the publisher through the advertising system manager, the publisher can identify that advertiser as having a specified relationship with the publisher, and in that sense “blacklist” the advertiser. Other techniques for identifying which advertisers cannot transact with a publisher through the system are possible. In some implementations, rather than providing a listing of advertisers inhibited from placing ads, the publisher may provide a listing of advertisers that are allowed to place offers for ads with the publisher, i.e., a “whitelist”. For example, the publisher may be presented a listing of available advertisers (e.g., advertisers that have registered with the system or advertisers that have previously placed offers) and identify for the advertising system manager those advertisers that are allowed to place ads with the publisher. In addition, the publisher may query a listing of available advertisers for specific advertisers. The system may then determine which advertisers are inhibited from placing ads and offers for ads.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

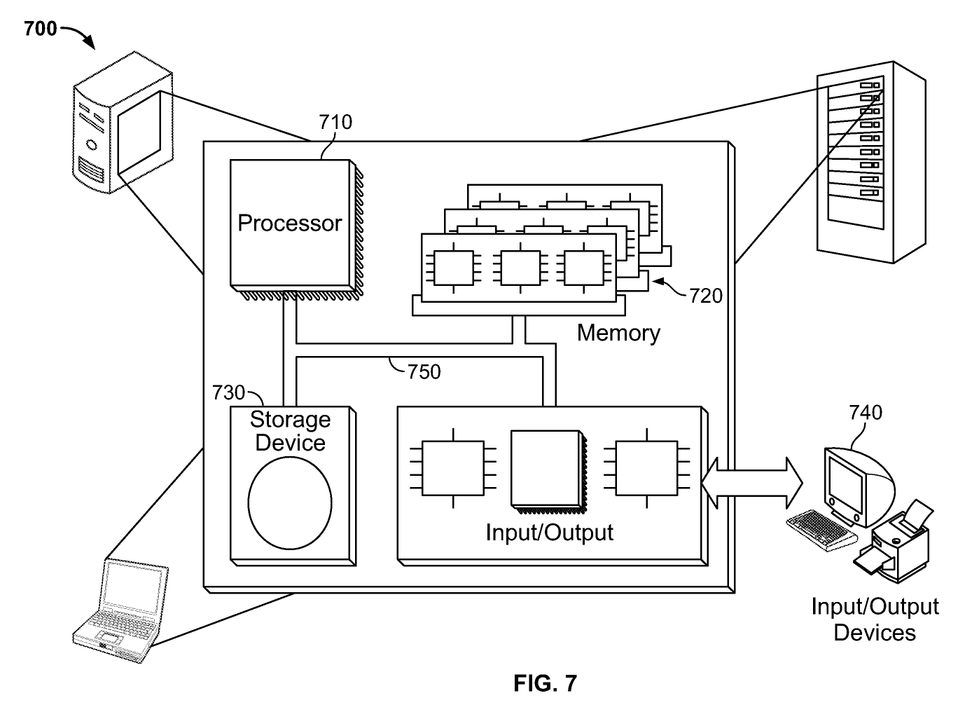

Referring now to FIG. 7, a schematic diagram of an example computer system 700 is shown. The system 700 can be used for the operations described in association with the process 700 shown in FIG. 7, according to one implementation. For example, one or more of the systems 700 can be used to implement a server hosting the advertising system manager 104, the advertisers 102 and/or the publishers 106 (see FIG. 1).

The system 700 includes a processor 710, a memory 720, a storage device 730, and an input/output device 740. Each of the components 710, 720, 730, and 740 can, for example, be interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740. In some embodiments, a parallel processing set of systems 700 connected over a network may be employed, clustered into one or more server centers.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 includes a keyboard and/or pointing device. In another implementation, the input/output device 740 includes a display unit for displaying graphical user interfaces.

A module, as the term is used throughout this application, can be a piece of hardware that encapsulates a function, can be firmware or can be a software application. An module can perform one or more functions, and one piece of hardware, firmware or software can perform the functions of more than one of the modules described herein. Similarly, more than one piece of hardware, firmware and/or software can be used to perform the function of a single module described herein.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a publisher” includes two or more publishers and reference to “an ad” includes a combination of two or more or different types ads.

A number of implementations have been described. Nevertheless, it will be understood that various modifications may be made without departing from the spirit and scope of the invention. Accordingly, other implementations are within the scope of this application.

What is claimed is:

1. A computer implemented method comprising:
receiving publisher information from a plurality of publishers, the publisher information including information about available print ad space;
receiving from an advertiser a request associated with a print ad;
identifying to the advertiser publishers with available print ad space, where the identified publishers include one or more of the publishers from the plurality of publishers and at least one publisher having a specified relationship with the advertiser; and
inhibiting placement of the print ad of the advertiser with the at least one publisher having the specified relationship with the advertiser.

2. The computer implemented method of claim 1, further comprising determining if the advertiser has a specified relationship with one or more of the identified publishers.

3. The computer implemented method of claim 2, further comprising:
receiving an offer from the advertiser defining terms for placing the print ad in a publication of one or more of the identified publishers including a publication of the at least one publisher having the specified relationship with the advertiser;
wherein determining if the advertiser has a specified relationship with one or more of the identified publishers comprises receiving an indication of the specified relationship from the publisher having the specified relationship with the advertiser after the publisher receives the offer from the advertiser.

4. The computer implemented method of claim 1, wherein inhibiting the advertiser from placing the print ad with the at least one publisher having the specified relationship comprises preventing the advertiser from submitting an offer for placing the print ad in a publication of the publisher with whom the advertiser has the specified relationship.

5. The computer implemented method of claim 1, wherein inhibiting the advertiser from placing the print ad with the at least one publisher having the specified relationship comprises preventing the advertiser from selecting the at least one publisher from a list of the identified publishers presented to the advertiser when the advertiser is generating the offer.

6. The computer implemented method of claim 1, further comprising:
providing an interface to the advertiser including:
a list of the identified publishers including at least a portion of the publisher information for each publisher; and
a link for each identified publisher on the list that does not have the specified relationship with the advertiser, wherein an advertiser can select a link to submit an offer for placing the print ad in a publication of the corresponding publisher.

7. The computer implemented method of claim 1, further comprising:
receiving from at least some of the publishers an identification of one or more advertisers having the specified relationship to the publisher; and
determining if the advertiser has the specified relationship with one of the identified publishers including comparing the advertiser to the one or more advertisers identified by the publishers.

8. The computer implemented method of claim 1, wherein the request from the advertiser includes search criteria related to publisher attributes, and wherein identifying the publishers is based at least partially on the received search criteria.

9. The computer implemented method of claim 1, wherein the specified relationship comprises a previous advertising relationship with a publisher.

10. The computer implemented method of claim 1, further comprising presenting one or more indicia to indicate which of the identified publishers has the specified relationship with the advertiser.

11. The computer implemented method of claim 1, further comprising:
receiving a request from the advertiser to submit an offer to the at least one publisher having the specified relationship with the advertiser; and
in response to the request, presenting contact information for the at least one publisher to the advertiser such that the advertiser can contact the at least one publisher directly.

12. The computer implemented method of claim 1, further comprising:
receiving an offer from the advertiser defining terms for placing the print ad in a publication of one or more of the identified publishers; and
receiving from at least one of the identified publishers to whom the offer is submitted a rejection of the offer and an identification that the advertiser has the specified relationship with the publisher.

13. The computer implemented method of claim 1, wherein inhibiting placement of the print ad of the advertiser with the at least one publisher having the specified relationship comprises selectively inhibiting placement based on offer criteria defined by the publisher with the specified relationship with the advertiser.

14. The computer implemented method of claim 13, further comprising:
receiving an offer from the advertiser defining terms for placing the print ad in a publication of one or more of the identified publishers including a publication of the at least one publisher having the specified relationship with the advertiser;
wherein selectively inhibiting placement based on the offer criteria comprises comparing the offer received from the advertiser having the specified relationship with the publisher to the offer criteria, and accepting the offer for placement if the offer criteria is satisfied.

15. The computer implemented method of claim 13, further comprising:
receiving an offer from the advertiser defining terms for placing the print ad in a publication of one or more of the identified publishers including a publication of the at least one publisher having the specified relationship with the advertiser;
wherein selectively inhibiting placement based on the offer criteria comprises comparing one or more other offers received by the publisher with specified relationship relating to the same available print ad space as the offer from the advertiser, and accepting the offer for placement if the offer criteria is not satisfied by the one or more other offers.

16. The computer implemented method of claim 1, wherein the publisher information further includes an identification of advertisers from whom the publisher will entertain offers for ad placement, the method further comprising:
inhibiting placement of the print ad of the advertiser with any publisher that has not identified the advertiser as an advertiser from whom the publisher will entertain offers for ad placement.

17. The computer implemented method of claim 16, wherein identifying to the advertiser publishers with available print ad space includes determining if the advertise is an advertiser with whom publishers having available print ad space will entertain offers from, and excluding publishers from the identified publishers those publishers that will not entertain offers from the advertiser.

18. An article comprising machine-readable medium storing instructions for managing advertising requests, the instructions operable to cause data processing apparatus to perform operations comprising:
receiving publisher information from a plurality of publishers, the publisher information including information about available print ad space;
receiving from an advertiser a request associated with a print ad;
identifying to the advertiser publishers with available print ad space, where the identified publishers include one or more of the publishers from the plurality of publishers and at least one publisher having a specified relationship with the advertiser; and
inhibiting placement of the print ad of the advertiser with the at least one publisher having the specified relationship with the advertiser.

19. The article of claim 18, wherein the instructions are further operable to cause data processing apparatus to perform operations comprising determining if the advertiser has a specified relationship with one or more of the identified publishers.

20. The article of claim 18, wherein the instructions are further operable to cause data processing apparatus to perform operations comprising:
receiving an offer from the advertiser defining terms for placing the print ad in a publication of one or more of the identified publishers including a publication of the at least one publisher having the specified relationship with the advertiser;
wherein determining if the advertiser has a specified relationship with one or more of the identified publishers comprises receiving an indication of the specified relationship from the publisher having the specified relationship with the advertiser after the publisher receives the offer from the advertiser.

21. The article of claim 18, wherein inhibiting the advertiser from placing the print ad with the at least one publisher having the specified relationship comprises preventing the advertiser from submitting an offer for placing the print ad in a publication of the publisher with whom the advertiser has the specified relationship.

22. The article of claim 18, wherein inhibiting the advertiser from placing the print ad with the at least one publisher having the specified relationship comprises preventing the advertiser from selecting the at least one publisher from a list of the identified publishers presented to the advertiser when the advertiser is generating the offer.

23. The article of claim 18, wherein the instructions are further operable to cause data processing apparatus to perform operations comprising:
providing an interface to the advertiser including:
a list of the identified publishers including at least a portion of the publisher information for each publisher; and
a link for each identified publisher on the list that does not have the specified relationship with the advertiser, wherein an advertiser can select a link to submit an offer for placing the print ad in a publication of the corresponding publisher.

24. The article of claim 18, wherein the instructions are further operable to cause data processing apparatus to perform operations comprising:
receiving from at least some of the publishers an identification of one or more advertisers having the specified relationship to the publisher; and
determining if the advertiser has the specified relationship with one of the identified publishers including comparing the advertiser to the one or more advertisers identified by the publishers.

25. The article of claim 18, wherein the request from the advertiser includes search criteria related to publisher attributes, and wherein identifying the publishers is based at least partially on the received search criteria.

26. The article of claim 18, wherein the specified relationship comprises a previous advertising relationship with a publisher.

27. The article of claim 18, wherein the instructions are further operable to cause data processing apparatus to perform operations comprising presenting one or more indicia to indicate which of the identified publishers has the specified relationship with the advertiser.

28. The article of claim 18, wherein the instructions are further operable to cause data processing apparatus to perform operations comprising:
receiving a request from the advertiser to submit an offer to the at least one publisher having the specified relationship with the advertiser; and
in response to the request, presenting contact information for the at least one publisher to the advertiser such that the advertiser can contact the at least one publisher directly.

29. The article of claim 18, wherein the instructions are further operable to cause data processing apparatus to perform operations comprising:
receiving an offer from the advertiser defining terms for placing the print ad in a publication of one or more of the identified publishers; and
receiving from at least one of the identified publishers to whom the offer is submitted a rejection of the offer and an identification that the advertiser has the specified relationship with the publisher.

30. The article of claim 18, wherein inhibiting placement of the print ad of the advertiser with the at least one publisher having the specified relationship comprises selectively inhibiting placement based on offer criteria defined by the publisher with the specified relationship with the advertiser.

31. The article of claim 30, wherein the instructions are further operable to cause data processing apparatus to perform operations comprising:
receiving an offer from the advertiser defining terms for placing the print ad in a publication of one or more of the identified publishers including a publication of the at least one publisher having the specified relationship with the advertiser;
wherein selectively inhibiting placement based on the offer criteria comprises comparing the offer received from the advertiser having the specified relationship with the publisher to the offer criteria, and accepting the offer for placement if the offer criteria is satisfied.

32. The article of claim 30, wherein the instructions are further operable to cause data processing apparatus to perform operations comprising:
receiving an offer from the advertiser defining terms for placing the print ad in a publication of one or more of the identified publishers including a publication of the at least one publisher having the specified relationship with the advertiser;
wherein selectively inhibiting placement based on the offer criteria comprises comparing one or more other offers received by the publisher with specified relationship relating to the same available print ad space as the offer from the advertiser, and accepting the offer for placement if the offer criteria is not satisfied by the one or more other offers.

33. A system comprising:
a memory storing publisher information; and
an analysis module adapted to:
receive publisher information from a plurality of publishers, the publisher information including information about available print ad space;
receive from an advertiser a request associated with a print ad;
identify publishers with available print ad space, where the identified publishers includes one or more of the publishers from the plurality of publishers and at least one publisher having a specified relationship with the advertiser; and
inhibit placement of the print ad of the advertiser with the at least one publisher having the specified relationship with the advertiser.

34. The system of claim 33, further comprising:
a presentation module adapted to present to the advertiser a list of the identified publishers.

35. The system of claim 33, wherein the analysis module is further adapted to inhibit selection of at least one publisher on the list with the specified relationship with the advertiser.

36. A system comprising:
means for receiving publisher information from a plurality of publishers, the publisher information including information about available print ad space;
means for receiving from an advertiser a request associated with a print ad;
means for identifying to the advertiser publishers with available print ad space, where publishers include one or more of the publishers from the plurality of publishers and at least one publisher having a specified relationship with the advertiser; and
inhibiting placement of the print ad of the advertiser with the at least one publisher having the specified relationship with the advertiser.

37. A computer implemented method comprising:
receiving publisher information from a plurality of publishers, the publisher information including information about available print ad space and including an identification of advertisers from whom the publisher will entertain offers for ad placement;
receiving from an advertiser a request associated with a print ad;
identifying to the advertiser publishers with available print ad space; and
inhibiting placement of the print ad of the advertiser with any publisher that has not identified the advertiser as an advertiser from whom the publisher will entertain offers for ad placement.

38. The computer implemented method of claim 37, wherein identifying to the advertiser publishers with available print ad space includes determining if the advertiser is an advertiser with whom publishers having available print ad space will entertain offers from, and excluding publishers from the identified publishers those publishers that will not entertain offers from the advertiser.
